(19) United States
(12) Patent Application Publication
(10) Pub. No.: US 2016/0102237 A1
(43) Pub. Date: Apr. 14, 2016

(54) WELLBORE SERVICING COMPOSITIONS AND METHODS OF MAKING AND USING SAME

(71) Applicant: HALLIBURTON ENERGY SERVICES, INC., Houston, TX (US)

(72) Inventors: Kenneth W. Pober, Houston, TX (US); Cato R. McDaniel, The Woodlands, TX (US)

(21) Appl. No.: 14/893,400

(22) PCT Filed: Jul. 31, 2013
(86) PCT No.: PCT/US2013/052946

§ 371 Date: Nov. 23, 2015

(51) Int. Cl. C09K 8/06; E21B 21/00; E21B 43/16

(52) U.S. Cl. CPC C09K 8/06; E21B 43/16; E21B 21/003

(57) ABSTRACT

A method of servicing a wellbore in a subterranean formation comprising preparing a wellbore servicing fluid comprising an alkoxylated humus material and an aqueous base fluid, wherein the alkoxylated humus material comprises an ethoxylated humus material and/or a C3+ alkoxylated humus material, and placing the wellbore servicing fluid in the wellbore and/or subterranean formation to modify the permeability of at least a portion of the wellbore and/or subterranean formation. A method of drilling a wellbore in a subterranean formation comprising preparing a drilling fluid comprising an alkoxylated humus material and an aqueous base fluid, wherein the alkoxylated humus material comprises an ethoxylated humus material and/or a C3+ alkoxylated humus material, and placing the drilling fluid in the wellbore and/or subterranean formation.

### BACKGROUND

This disclosure relates to methods of servicing a wellbore. More specifically, it relates to methods of treating a wellbore with a fluid loss additive.

Natural resources such as gas, oil, and water residing in a subterranean formation or zone are usually recovered by drilling a wellbore down to the subterranean formation while circulating a drilling fluid in the wellbore. After terminating the circulation of the drilling fluid, a string of pipe, e.g., casing, is run in the wellbore. The drilling fluid is then usually circulated downward through the interior of the pipe and upward through the annulus, which is located between the exterior of the pipe and the walls of the wellbore. Next, primary cementing is typically performed whereby a cement slurry is placed in the annulus and permitted to set into a hard mass (i.e., sheath) to thereby attach the string of pipe to the walls of the wellbore and seal the annulus. Subsequent secondary cementing operations may also be performed.

In wellbore servicing operations, loss of fluid to the wellbore and/or subterranean formation can detrimentally affect the performance of wellbore servicing fluids, the permeability of the wellbore and/or subterranean formation, and the economics of the wellbore servicing operations. In particular, the wellbore servicing fluids may enter and be “lost” to the subterranean formation via lost circulation zones (LCZs) for example, depleted zones, zones of relatively low pressure, LCZs having naturally occurring fractures, weak zones having fracture gradients exceeded by the hydrostatic pressure of a drilling fluid, and so forth. As a result, the service provided by such wellbore servicing fluid can be more difficult to achieve. For example, a drilling fluid may be lost to the wellbore and/or subterranean formation, resulting in the circulation of the fluid in the wellbore and/or subterranean formation being terminated and/or too low to allow for further drilling of the wellbore. Fluid loss additives (FLAs) are chemical additives used to control the loss of fluid to the wellbore and/or subterranean formation. However, when FLAs are tailored for high temperature environments, the cost of such specialized additives can drive up the cost of the wellbore servicing operations. Thus an ongoing need exists for improved FLAs and methods of utilizing same.

### SUMMARY

Disclosed herein is a method of servicing a wellbore in a subterranean formation comprising preparing a wellbore servicing fluid comprising an alkoxylated humus material and an aqueous base fluid, wherein the alkoxylated humus material comprises an ethoxylated humus material and/or a C3+ alkoxylated humus material, and placing the wellbore servicing fluid in the wellbore and/or subterranean formation to modify the permeability of at least a portion of the wellbore and/or subterranean formation.

Also disclosed herein is a method of drilling a wellbore in a subterranean formation comprising preparing a drilling fluid comprising an alkoxylated humus material and an aqueous base fluid, wherein the alkoxylated humus material comprises an ethoxylated humus material and/or a C3+ alkoxylated humus material, and placing the drilling fluid in the wellbore and/or subterranean formation.

Further disclosed herein is a method of servicing a wellbore in a subterranean formation comprising preparing a wellbore servicing fluid comprising an alkoxylated humus material and an aqueous base fluid, wherein the alkoxylated humus material comprises an ethoxylated lignite, and placing the wellbore servicing fluid in the wellbore and/or subterranean formation to modify the permeability of at least a portion of the wellbore and/or subterranean formation.

Further disclosed herein is a pumpable wellbore servicing fluid comprising an alkoxylated humus material in an amount of from about 0.25 wt. % to about 5.0 wt. % based on the total weight of the wellbore servicing fluid, wherein the alkoxylated humus material comprises an ethoxylated humus material and/or a C3+ alkoxylated humus material.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques below, including the exemplary designs and implementations illustrated and described herein, but may be modified within the scope of the appended claims along with their full scope of equivalents.

Disclosed herein are wellbore servicing fluids or compositions (collectively referred to herein as WSFs) and methods of using same. In an embodiment, the wellbore servicing fluid may comprise an alkoxylated humus material (e.g., an ethoxylated humus material and/or a C3+ alkoxylated humus material) and a sufficient amount of an aqueous base fluid to form a pumpable WSF. Utilization of a WSF comprising an alkoxylated humus material (e.g., an ethoxylated humus material and/or a C3+ alkoxylated humus material) in the methods disclosed herein may advantageously modify the permeability of at least a portion of a wellbore and/or subterranean formation. In an embodiment, the wellbore servicing fluid is formulated as a drilling fluid or mud (e.g., a water based drilling fluid or mud) having advantageous fluid loss characteristics, for example in high temperature drilling applications.

In an embodiment, the WSF comprises an alkoxylated humus material (AHM). In an embodiment, the AHM may function as a fluid loss additive (FLA) in the wellbore servicing fluid, for example a water based drilling fluid or mud. Generally, FLAs are chemical compounds or additives that are specifically designed to control the loss of fluid to the wellbore and/or subterranean formation by lowering the volume of filtrate that passes through a filter medium (e.g., wellbore and/or subterranean formation), thereby modifying the permeability of at least a portion of such filter medium. In an embodiment, a FLA may modify the permeability of at least a portion of a wellbore and/or subterranean formation (e.g., a wellbore wall and/or a filtercake formed on the wellbore wall during drilling).

In an embodiment, the AHM comprises an ethoxylated humus material (EHM), a C3+ alkoxylated humus material (CAHM), or combinations thereof. In an embodiment, the AHMs may be obtained by heating a reaction mixture comprising a humus material, an alkoxylating agent (e.g., ethylene oxide and/or C3+ cyclic ether), a catalyst and an inert reaction solvent. In an embodiment, the reaction mixture may be heated in a substantially oxygen-free atmosphere to yield the AHMs.

In an embodiment, the reaction mixture comprises a humus material. In an embodiment, the humus material references a brown or black material derived from decomposition of plant and/or animal substances. Generally, humus represents the organic portion of soil that will not undergo any further decomposition or degradation, and which comprises complex molecules resembling or incorporating at least a portion of a humic acid-like structure. In an embodiment, the humus material may be comprised of a naturally-occurring material. Alternatively, the humus material comprises a synthetic material, such as for example a material derived from the chemical modification of a naturally-occurring material. Alternatively, the humus material comprises a mixture of a naturally-occurring and synthetic material.

In an embodiment, the humus material comprises brown coal, lignite, subbituminous coal, leonardite, humic acid, a compound characterized by Structure I, fulvic acid, humin, peat, lignin, and the like, or combinations thereof.

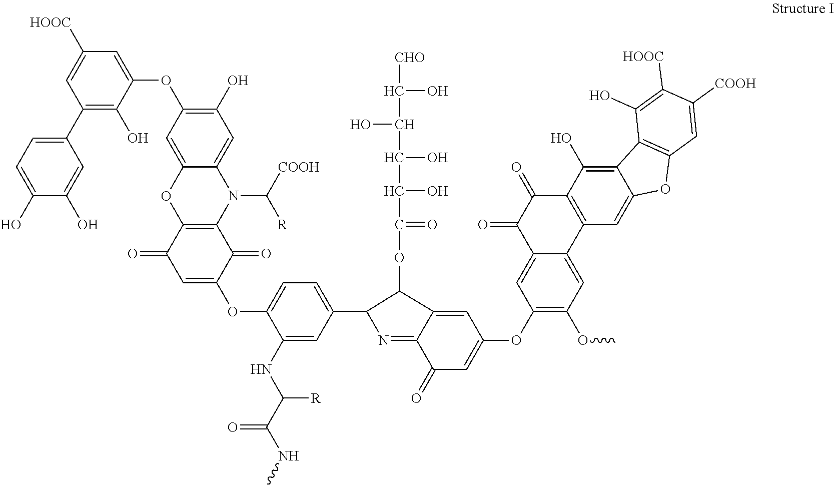

The wavy lines in Structure I represent the remainder of the molecule (e.g., a humic acid molecule).

In an embodiment, the humus material comprises brown coal. Brown coal generally comprises a broad and variable group of low rank coals characterized by their brownish coloration and high moisture content (e.g., greater than about 50 wt. % water, by weight of the brown coal). Brown coals typically include lignite and some subbituminous coals. The coal ranks as referred to herein are according to the U.S. Coal Resource and Classification System.

In an embodiment, the humus material comprises lignite. Lignite is generally a soft yellow to dark brown or rarely black coal with a high inherent moisture content, sometimes as high as about 70 wt. % water, but usually comprises a water content of from about 20 wt. % to about 60 wt. %, by weight of the lignite. Lignite is considered the lowest rank of coal, formed from peat at shallow depths, with characteristics that put it somewhere between subbituminous coal and peat.

In an embodiment, the humus material comprises subbituminous coal. Subbituminous coal, also referred to as black lignite, is generally a dark brown to black coal, intermediate in rank between lignite and bituminous coal. Subbituminous coal is characterized by greater compaction than lignite as well as greater brightness and luster. Subbituminous coal contains less water than lignite, e.g., typically from about 10 wt. % to about 25 wt. % water, by weight of the subbituminous coal.

In an embodiment, the humus material comprises leonardite. Leonardite is a soft waxy, black or brown, shiny, vitreous mineraloid that is associated with near-surface mining. Leonardite is an oxidation product of lignite and is a rich source of humic acid. In an embodiment, leonardite may comprises up to 90 wt. % humic acid, by weight of the leonardite.

In an embodiment, the humus material comprises humic acid. Humic acid is produced by biodegradation of dead organic matter and represents one of the major organic compound constituents of soil (humus), peat, coal, and may constitute as much as about 95 wt. % of the total dissolved organic matter in aquatic systems. Humic acid is one of two classes of natural acidic organic polymers that are found in soil, and comprises a complex mixture of many different acids containing carboxyl and phenolate groups. In an embodiment, the humic acid comprises a compound characterized by Structure I. Humic acid can generally be characterized by a molecular weight in the range of from about 10,000 Da to about 100,000 Da.

In an embodiment, the humus material comprises fulvic acid. Fulvic acid is the other one of two classes of natural acidic organic polymers that are found in soil (humus), along with humic acid. Fulvic acid is characterized by an oxygen content about twice as high as the oxygen content of humic acid, and by a molecular weight lower than the molecular weight of the humic acid. Fulvic acid can generally be characterized by a molecular weight in the range of from about 1,000 Da to about 10,000 Da.

In an embodiment, the humus material comprises humin. Humin or humin complexes are another major constituent of soil (humus) along with humic acid and fulvic acid. Humin or humin complexes are very large substances and are considered macro-organic substances due to their molecular weights that are generally in the range of from about 100,000 Da to about 10,000,000 Da.

In an embodiment, the humus material comprises peat. Peat or turf is an accumulation of a spongy material formed by the partial decomposition of organic matter, primarily plant material, e.g., partially decayed vegetation. Peat generally forms in wetland conditions, where flooding obstructs flows of oxygen from the atmosphere, slowing rates of decomposition.

In an embodiment, the humus material comprises lignin. Lignin is a complex oxygen-containing biopolymer most commonly derived from wood. Lignin is the second most abundant organic polymer on the planet, exceeded only by cellulose.

In an embodiment, the humus material may be subjected to a dehydration process (e.g., a water or moisture removal process) prior to adding the humus material to the reaction mixture or to any pre-mixed components thereof. The dehydration of the humus materials may be accomplished by using any suitable methodology, such as for example contacting the humus materials with superheated steam, convection drying, azeotropic distillation, azeotropic distillation with xylene, toluene, benzene, mesitylene, etc. In an embodiment, the humus materials may be dehydrated by heating the humus material (for example, in an oven or dryer such as a rotary dryer) at temperatures of from about 50° C. to about 125° C., alternatively from about 55° C. to about 120° C., or alternatively from about 60° C. to about 110° C. In an embodiment, the humus material suitable for adding to the reaction mixture or to any pre-mixed components thereof comprises a water content of less than about 3.5 wt. %, alternatively less than about 3 wt. %, alternatively less than about 2.5 wt. %, or alternatively less than about 2 wt. %, by weight of the humus material. As will be appreciated by one of skill in the art, and with the help of this disclosure, the dehydration process of the humus material is meant to remove all readily removable water, such that the catalyst would not be inactivated by reacting with water. As will be appreciated by one of skill in the art, and with the help of this disclosure, while it may be desirable to remove all water from the humus material, for practical purposes it may be sufficient to remove water from the humus material down to “tightly-bound water” (e.g., hydration water) level, which tightly-bound water would not be readily available to interact with and inactivate/kill the catalyst.

In an embodiment, the humus material comprises a particle size such that equal to or greater than about 97 wt. % passes through an about 80 mesh screen (U.S. Sieve Series) and equal to or greater than about 55 wt. % passes through an about 200 mesh screen (U.S. Sieve Series); or alternatively equal to or greater than about 70 wt. % passes through an about 140 mesh screen (U.S. Sieve Series) and equal to or greater than about 60 wt. % passes through an about 170 mesh screen (U.S. Sieve Series).

A commercial example of a humus material suitable for use in the present disclosure includes CARBONOX filtration control agent. CARBONOX filtration control agent is a naturally occurring product that displays dispersive/thinning characteristics in water-based drilling fluid systems and is available from Halliburton Energy Services, Inc.

In an embodiment, the humus material is present within the reaction mixture in an amount of from about 1 wt. % to about 50 wt. %, alternatively from about 2 wt. % to about 10 wt. %, alternatively from about 3 wt. % to about 7 wt. %, or alternatively from about 3 wt. % to about 5 wt. %, based on the total weight of the reaction mixture.

In an embodiment, the reaction mixture comprises an alkoxylating agent (e.g., ethylene oxide and/or C3+ cyclic ether). A C3+ cyclic ether refers to a cyclic ether (e.g., an epoxide or a cyclic ether with three ring atoms, generally two carbon ring atoms and one oxygen ring atom; a cyclic ether with four ring atoms, generally three carbon ring atoms and one oxygen ring atom; etc.) that has a total number of carbon atoms of equal to or greater than 3 carbon atoms, alternatively equal to or greater than 4 carbon atoms, alternatively equal to or greater than 5 carbon atoms, alternatively from about 3 carbon atoms to about 20 carbon atoms, alternatively from about 4 carbon atoms to about 15 carbon atoms, or alternatively from about 5 carbon atoms to about 10 carbon atoms. The alkoxylating agent may react with the humus material in the reaction mixture to yield an AHM (e.g., EHM and/or CAHM). Without wishing to be limited by theory, the alkoxylating agent may react with one or more functional groups of the humus materials, such as for example alcohol groups, phenol groups, carboxyl groups, amine groups, sulfhydryl groups, to form the AHM (e.g., EHM and/or CAHM). The alkoxylating agent may alkoxylate the humus material, e.g., introduce alkoxylating elements/groups/branches in the structure of the humus material to yield an AHM (e.g., EHM and/or CAHM). For purposes of the disclosure herein, a single alkoxylating agent (e.g., ethylene oxide, C3+ cyclic ether, a C3+ epoxide, oxetane, etc.) molecule that attaches to a humus material will be referred to herein as an “alkoxy unit” (e.g., an “ethoxy unit,” a “C3+ cyclic ether unit,” a “C3+ epoxide unit,” an “oxetane unit,” etc.). In an embodiment, an alkoxylating element comprises one or more alkoxy units, which may be the same or different from each other.

In an embodiment, the alkoxylating agent comprises ethylene oxide, a C3+ cyclic ether, or combinations thereof. In an embodiment, the C3+ cyclic ether comprises oxetane as characterized by Structure II, an epoxide (e.g., C3+ epoxide) compound characterized by Structure III, or combinations thereof,

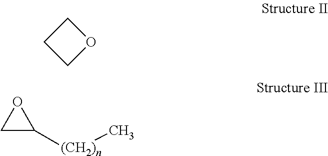

where the repeating methylene (—CH₂—) unit may occur n times with the value of n ranging from about 0 to about 3, alternatively from about 0 to about 2, or alternatively from about 0 to about 1.

In an embodiment, the C3+ cyclic ether (e.g., C3+ epoxide) characterized by Structure III comprises propylene oxide as characterized by Structure IV, butylene oxide as characterized by Structure V, pentylene oxide as characterized by Structure VI, or combinations thereof.

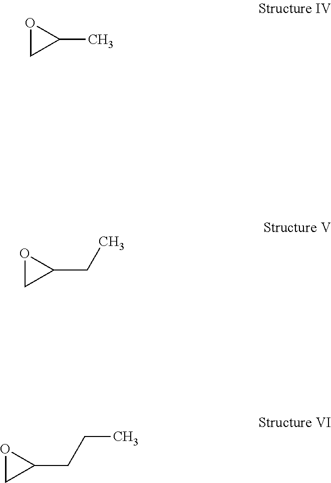

In an embodiment, the alkoxylating agent comprises ethylene oxide and the resulting alkoxylated humus material comprises an EHM. In another embodiment, the alkoxylating agent comprises a C3+ cyclic ether and the resulting alkoxylated humus material comprises a CAHM.

In yet another embodiment, the alkoxylating agent comprises ethylene oxide and a C3+ cyclic ether, and the resulting alkoxylated humus material may be a mixed alkoxylated humus material, such as for example a propoxylated/ethoxylated humus material, a butoxylated/ethoxylated humus material, a pentoxylated/ethoxylated humus material, etc. In an embodiment, the weight ratio between ethylene oxide and C3+ cyclic ether may be in the range of from about 10:1 to about 1:10, alternatively from about 5:1 to about 1:10, alternatively from about 5:1 to about 1:1, alternatively from about 1.5:1 to about 1:1, alternatively from about 1:1 to about 1:5, or alternatively from about 1:1 to about 1:2.

In an embodiment, the alkoxylating agent is present within the reaction mixture in a weight ratio of alkoxylating agent to humus material of from about 0.5:1 to about 50:1, alternatively from about 5:1 to about 40:1, or alternatively from about 10:1 to about 30:1.

In an embodiment, the reaction mixture comprises a catalyst. The catalyst may assist in the reaction between the humus material and the alkoxylating agent, but it is expected that the catalyst is not consumed during the chemical reaction (e.g., the alkoxylation of humus materials).

In an embodiment, the catalyst comprises a strong base catalyst. In an alternative embodiment, the catalyst comprises a strong acid catalyst.

Nonlimiting examples of strong base catalysts suitable for use in the present disclosure include sodium methoxide, potassium methoxide, sodium ethoxide, potassium ethoxide, and the like, or combinations thereof.

In an embodiment, the strong base catalyst is present within the reaction mixture in an amount of from about 0.1 wt. % to about 75 wt. %, alternatively from about 0.5 wt. % to about 60 wt. %, or alternatively from about 1 wt. % to about 55 wt. %, based on the total weight of the humus material.

In an embodiment, the strong acid catalyst comprises a mixture of (i) esters of titanic and/or zirconic acid with monoalkanols and (ii) sulfuric acid and/or alkanesulfonic acids and/or aryloxysulfonic acids, wherein the monoalkanols comprise from about 1 to about 4 carbon atoms, and the alkanesulfonic acids comprise from about 1 to about 6 carbon atoms. Nonlimiting examples of alkanesulfonic acids suitable for use in the present disclosure include methanesulfonic acid, ethanesulfonic acid, propanesulfonic acid, butanesulfonic acid, hexanesulfonic acids, or combinations thereof. Nonlimiting examples of aryloxysulfonic acids suitable for use in the present disclosure include phenolsulfonic acid.

In an embodiment, the strong acid catalyst comprises a mixture of (i) HF and (ii) a metal alkoxide and/or a mixed metal alkoxide, such as for example aluminum and titanium metal alkoxides and/or mixed alkoxides. In such embodiment, the metal alkoxides may be characterized by the general formula M(OCₐH₂ₐ₊₁)_{b}, wherein M is a metal, b is the valence of the metal M, and each a can independently be from about 1 to about 22 carbon atoms, alternatively from about 1 to about 18 carbon atoms, or alternatively from about 1 to about 14 carbon atoms. In an embodiment, the metal may be selected from the group consisting of aluminum, gallium, indium, thallium, titanium, zirconium and hafnium. In an embodiment, b may be either 3 or 4, depending on the valence of the metal M.

Nonlimiting examples of strong acid catalysts suitable for use in the present disclosure include HF/(CH₃O)₃Al; HF/(C₂H₅O)₃Al; HF/(CH₃O)₂(C₂H₅O)Al; HF/(C₂H₅O)₃Al; HF/(CH₃O)₂(C₂H₅O)₂Ti; HF/(CH₃O)(C₂H₅O)₃Ti; HF/(C₂₀H₄₁O)₄Ti; HF/(C₂₀H₄₁O)₃Al; HF/(i-C₃H₇O)₃Al; HF/(CH₃O)₄Ti; HF/(C₂H₅O)₄Ti; HF/(i-C₃H₇O)₄Ti; HF/(CH₃O)₄Zr; HF/(C₂H₅O)_{d}Zr, HF/(CH₃O)(C₂H₅O)(i-C₃H₇O)Al; HF/(CH₃O)₂(C₂H₅O)(i-C₃H₇O)Ti; or combinations thereof.

In an embodiment, the strong acid catalyst is present within the reaction mixture in an amount of from about 0.01 wt. % to about 10 wt. %, alternatively from about 0.05 wt. % to about 10 wt. %, or alternatively from about 0.1 wt. % to about 2 wt. %, based on the total weight of the hummus material.

In an embodiment, the reaction mixture comprises an inert reaction solvent, alternatively referred to as an inert diluent. The inert reaction solvent will not react with the catalyst (e.g., will not cause the hydrolysis of the strong base catalyst) and will also not participate in the alkoxylation reaction between the humus material and the alkoxylating agent (e.g., ethylene oxide and/or C3+ cyclic ether), so as to avoid competing side reactions. The inert reaction solvent will not react with any of the reactants (e.g., the humus material, the alkoxylating agent). The inert reaction solvent will not engage in deleterious side reactions which would hinder the reaction between the humus material and the alkoxylating agent (e.g., ethylene oxide and/or C3+ cyclic ether). Without wishing to be limited by theory, the inert reaction solvent provides a liquid medium for the alkoxylation reaction of humus materials, e.g., a liquid medium in which the reactants (e.g., the humus material, the alkoxylating agent) can interact and react. In an embodiment, removal of water and/or dissolved O₂ may improve the yield of the alkoxylation reaction.

In an embodiment, the inert reaction solvent may be subject to a dehydration step (e.g., the removal of water), which may be accomplished by using any suitable methodology, such as for example the use of zeolites, azeotropic distillation, pervaporation, and the like, or combinations thereof. In an embodiment, the inert reaction solvent does not comprise a substantial amount of water. In an embodiment, the reaction solvent comprises water in an amount of less than about 1 vol. %, alternatively less than about 0.1 vol. %, alternatively less than about 0.01 vol. %, alternatively less than about 0.001 vol. %, alternatively less than about 0.0001 vol. %, or alternatively less than about 0.00001 vol. %, based on the total volume of the inert reaction solvent.

In an embodiment, the inert reaction solvent may be subject to a deoxygenation step (e.g., removal of dissolved O₂), which may be accomplished by using any suitable methodology, such as for example purging an inert gas (e.g., nitrogen, helium, argon, etc.) through the inert reaction solvent (e.g., bubbling an inert gas through the solvent). In an embodiment, the inert reaction solvent does not comprise a substantial amount of dissolved O₂. In an embodiment, the reaction solvent comprises dissolved O₂ in an amount of less than about 1 wt. %, alternatively less than about 0.1 wt. %, alternatively less than about 0.01 wt. %, alternatively less than about 0.001 wt. %, alternatively less than about 0.0001 wt. %, or alternatively less than about 0.00001 wt. %, based on the total weight of the inert reaction solvent.

Nonlimiting examples of inert reaction solvents suitable for use in the present disclosure include C₆-C₁₂ liquid aromatic hydrocarbons; toluene, ethylbenzene, xylenes, o-xylene, m-xylene, p-xylene, trimethylbenzenes, cumene (i.e., isopropylbenzene), mesitylene (i.e., 1,3,5-trimethylbenzene), 1,2,4-trimethylbenzene, 1,2,3-trimethylbenzene; and the like, or combinations thereof.

As will be appreciated by one of ordinary skill in the art, and with the help of this disclosure, the term “solvent” as used herein does not imply that any or all of the reactants are solubilized in the inert reaction solvent. In an embodiment, the humus material and the catalyst are less than about 25 wt. % soluble in the inert reaction solvent, alternatively less than about 20 wt. %, alternatively less than about 15 wt. %, alternatively less than about 10 wt. %. alternatively less than about 5 wt. %, alternatively less than about 4 wt. %, alternatively less than about 3 wt. %, alternatively less than about 2 wt. %, alternatively less than about 1 wt. %, based on the weight of the inert reaction solvent. In an embodiment, the reaction mixture comprises a slurry comprising the humus material, the alkoxylating agent (e.g., ethylene oxide and/or C3+ cyclic ether), the strong base catalyst and the inert reaction solvent. In another embodiment, the strong acid catalyst may be soluble in the inert reaction solvent. In yet another embodiment, the reaction mixture comprises a slurry comprising the humus material, the alkoxylating agent (e.g., ethylene oxide and/or C3+ cyclic ether), the strong acid catalyst and the inert reaction solvent.

In an embodiment, the inert reaction solvent is present within the reaction mixture in an amount of from about 30 wt. % to about 90 wt. %, alternatively from about 30 wt. % to about 70 wt. %, alternatively from about 35 wt. % to about 65 wt. %, alternatively from about 40 wt. % to about 60 wt. %, or alternatively from about 45 wt. % to about 55 wt. %, based on the total weight of the reaction mixture. Alternatively, the inert reaction solvent may comprise the balance of the reaction mixture after considering the amount of the other components used.

In an embodiment, the AHM (e.g., EHM and/or CAHM) may be produced by heating a reaction mixture comprising a humus material, an alkoxylating agent (e.g., ethylene oxide and/or C3+ cyclic ether), a catalyst and an inert reaction solvent. In an embodiment, the reaction mixture may be heated by using any suitable methodology (e.g., a fired heater, heat exchanger, heating mantle, burners, etc.) to a temperature ranging from about 130° C. to about 170° C., alternatively from about 140° C. to about 160° C., or alternatively from about 145° C. to about 155° C. In an embodiment, the reaction mixture may be heated to a temperature of about 150° C.

In an embodiment, the reaction mixture may be heated (e.g., reacted) in a substantially oxygen-free atmosphere. For purposes of the disclosure herein, the term “atmosphere” refers to any space within the reaction vessel that is not occupied by the reaction mixture or any parts of the reaction vessel (e.g., a stirring device), for example a head space within a reactor vessel. In an embodiment, a substantially oxygen-free atmosphere comprises oxygen in an amount of less than about 1 vol. %, alternatively less than about 0.1 vol. %, alternatively less than about 0.01 vol. %, alternatively less than about 0.001 vol. %, alternatively less than about 0.0001 vol. %, or alternatively less than about 0.00001 vol. %, based on the total volume of the atmosphere in which the alkoxylation of the humus materials is carried out.

In an embodiment, the substantially oxygen-free atmosphere may be obtained by using any suitable methodology, such as for example purging a reaction vessel comprising the reaction mixture or any components thereof with an inert gas, i.e., a gas that does not participate in the alkoxylation reaction. For example, the reaction mixture may be maintained under an inert gas blanket for the duration of the alkoxylation reaction. Nonlimiting examples of inert gases suitable for use in the present disclosure include nitrogen, helium, argon, or combinations thereof.

In an embodiment, the components of the reaction mixture (e.g., the humus material, the alkoxylating agent, the catalyst and the inert reaction solvent) may be heated while being mixed together, and the heating may continue for the duration of the chemical modification reaction (e.g., alkoxylation of humus materials). In another embodiment, all components of the reaction mixture (e.g., the humus material, the alkoxylating agent, the catalyst and the inert reaction solvent) may be mixed together to form the reaction mixture prior to heating the reaction mixture. In an alternative embodiment, at least two components of the reaction mixture are pre-mixed and heated prior to the addition of the other components. In some embodiments, the humus material, the alkoxylating agent, and the catalyst may each be pre-mixed individually with a portion of the inert reaction solvent and heated, and then they may be mixed together in any suitable sequence to form the reaction mixture. In an embodiment, the mixing or pre-mixing of any of the components of the reaction mixture (e.g., the humus material, the alkoxylating agent, the catalyst and the inert reaction solvent) may be carried out under stirring or agitation by using any suitable methodology (e.g., magnetic stirring, mechanical stirring, a rotated reaction vessel having internal mixing structures, etc.). In an embodiment, the humus material, the catalyst and the inert reaction solvent are pre-mixed and heated prior to the addition of the alkoxylating agent to form the reaction mixture. When any of the components of the reaction mixture are pre-mixed, such pre-mixing generally occurs at the temperature at which it is intended to carry out the chemical modification of the humus materials (e.g., alkoxylation of humus materials), e.g., a temperature ranging from about 130° C. to about 170° C. In an embodiment, when a component of the reaction mixture is added to pre-mixed components, such addition may occur by adding all at once the entire amount of the component to the pre-mixed components. In an alternative embodiment, the component may be added in different portions/aliquots/charges to the pre-mixed components over a desired time period. For example, the total amount of the alkoxylating agent (e.g., ethylene oxide and/or C3+ cyclic ether) may be divided into a plurality of portions, which may either have equal weights or have weights different from each other, and each portion of the alkoxylating agent (e.g., ethylene oxide and/or C3+ cyclic ether) may be added to the pre-mixed components (e.g., the pre-mixed humus material, catalyst and inert reaction solvent) over a desired time period, such as for example each portion of the alkoxylating agent (e.g., ethylene oxide and/or C3+ cyclic ether) may be added to the pre-mixed components every hour. In an embodiment, when the alkoxylating agent (e.g., ethylene oxide and/or C3+ cyclic ether) is added to the other pre-mixed components in portions, the conditions (e.g., temperature, pressure) inside the reaction vessel where the chemical modification of the humus materials (e.g., alkoxylation of humus materials) is carried out might vary while each of the alkoxylating agent (e.g., ethylene oxide and/or C3+ cyclic ether) portions reacts with the humus material (e.g., alkoxylates the humus material). In such embodiment, the following portion of the alkoxylating agent (e.g., ethylene oxide and/or C3+ cyclic ether) may be added to the reaction vessel after the conditions (e.g., temperature, pressure) inside the reaction vessel have equilibrated (e.g., have reached a steady state, which may be the same or different when compared to the steady state conditions inside the reaction vessel prior to the addition of the previous portion of the alkoxylating agent).

In an embodiment, the reaction mixture or any pre-mixed components thereof may be heated in a substantially oxygen-free atmosphere to carry out the chemical modification of the humus materials, e.g., alkoxylation of humus materials. In an embodiment, the components of the reaction mixture (e.g., the humus material, the alkoxylating agent, the catalyst and the inert reaction solvent) may be mixed or pre-mixed in a substantially oxygen-free atmosphere. In an embodiment, the humus material, the catalyst and the inert reaction solvent are pre-mixed and heated in a substantially oxygen-free atmosphere prior to the addition of the alkoxylating agent (e.g., ethylene oxide and/or C3+ cyclic ether).

In an embodiment, the components of the reaction mixture (e.g., the humus material, alkoxylating agent, the catalyst and the inert reaction solvent) may be mixed or pre-mixed as previously described herein at a pressure at which it is intended to carry out the chemical modification reaction (e.g., alkoxylation of humus materials), e.g., a pressure in the range of from about 32 psi to about 300 psi, alternatively from about 25 psi to 250 psi, or alternatively from about 20 psi to 200 psi.

In an embodiment, the chemical modification reaction (e.g., alkoxylation of humus materials) may be carried out over a time period ranging from about 0.5 h to about 10 h, alternatively from about 0.5 h to about 7 h, or alternatively from about 0.5 h to about 3 h. In an embodiment, when any of the components of the reaction mixture (e.g., the humus material, the alkoxylating agent, the catalyst and the inert reaction solvent) are pre-mixed, such pre-mixing may occur for a time period ranging from about 0.5 h to about 1.5 h, or alternatively from about 0.5 h to about 1 h.

In an embodiment, the AHM (e.g., EHM and/or CAHM) may be recovered from the reaction mixture at the end of the alkoxylation reaction. The reaction may be terminated by removing the heat source and returning (e.g., cooling down) the reaction mixture to a temperature lower than the temperature required for the alkoxylation reaction, e.g., a temperature lower than about 130° C. The reaction mixture may be filtered to remove any solid particulates that might still be present in the reaction mixture.

In an embodiment, the inert reaction solvent may be removed from the reaction mixture at the end of the alkoxylation reaction by using any suitable methodology, such as for example flash evaporation, distillation, liquid-liquid-extraction, or combinations thereof. The removal of the inert reaction solvent may generally yield AHMs (e.g., recovered AHMs). Depending on the degree of alkoxylation of the AHMs (e.g., the extent of the chemical modification of the humus materials), the state of matter of the recovered AHMs may range from a liquid to a solid. As will be appreciated by one of ordinary skill in the art, and with the help of this disclosure, the degree of alkoxylation of the AHMs (e.g., the extent of the chemical modification of the humus materials) is dependent on the ratio of the alkoxylating agent to the humus material in the reaction mixture.

In an embodiment, the AHM obtained as previously described herein by using a strong base catalyst comprises a compound characterized by Structure VII:

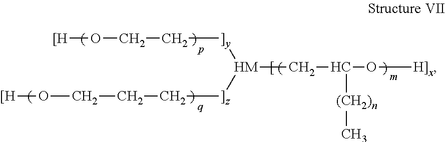

where HM represents the humus material; the repeating methylene (—CH₂—) unit may occur n times with the value of n ranging from about 0 to about 3, alternatively from about 0 to about 2, or alternatively from about 0 to about 1, as previously described for the C3+ cyclic ether (e.g., C3+ epoxide) compound characterized by Structure III; a repeating C3+ cyclic ether unit or C3+ epoxide unit that originates from the C3+ cyclic ether (e.g., C3+ epoxide) in the presence of a strong base catalyst may occur m times with the value of m ranging from about 1 to about 30, alternatively from about 2 to about 20, or alternatively from about 2 to about 10; a C3+ alkoxylating element may occur x times with the value of x ranging from about 0 to about 300, alternatively from about 2 to about 250, or alternatively from about 10 to about 200, per 100 g of humus material; a repeating ethoxy unit may occur p times with the value of p ranging from about 1 to about 30, alternatively from about 2 to about 20, or alternatively from about 2 to about 10; an ethoxylating element may occur y times with the value of y ranging from about 0 to about 200, alternatively from about 1 to about 150, or alternatively from about 2 to about 100, per 100 g of humus material; a repeating oxetane unit (e.g., when the C3+ cyclic ether used in the alkoxylation comprises oxetane as characterized by Structure II) may occur q times with the value of q ranging from about 1 to about 30, alternatively from about 2 to about 20, or alternatively from about 2 to about 10; and a C3+ alkoxylating element may occur z times with the value of z ranging from about 0 to about 300, alternatively from about 1 to about 250, or alternatively from about 2 to about 200, per 100 g of humus material. As will be appreciated by one of skill in the art, and with the help of this disclosure, x, y and z cannot all be 0 at the same time. For purposes of the disclosure herein, one or more alkoxy or alkoxylating units (e.g., a C3+ cyclic ether unit, a C3+ epoxide unit, an oxetane unit, an ethoxy unit) that attach to the humus material structure in the same point (e.g., via the same functional group of the humus material) will be referred to herein as an “alkoxyating element” (e.g., “C3+ alkoxylating element,” “ethoxylating element”). The C3+ alkoxylating element refers to an alkoxyating element that originates from a C3+ cyclic ether, such as for example oxetane, a C3+ epoxide, etc. For purposes of the disclosure herein, the description of various substituents (e.g., a substituent of an AHM, such as for example a C3+ alkoxylating element, an ethoxylating element, etc.) and parameters thereof (e.g., x, x1, y, z, p, q, m, m1) is understood to apply to all related structures, unless otherwise designated herein.

In an embodiment, the AHM (e.g., EHM and/or CAHM) obtained as previously described herein by using a strong acid catalyst comprises a compound characterized by Structure VIII:

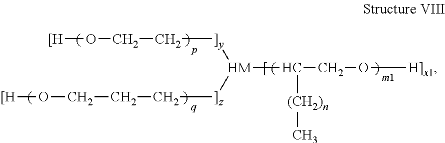

where the repeating C3+ cyclic ether unit that originates from the C3+ cyclic ether in the presence of a strong acid catalyst may occur m1 times with the value of m1 ranging from about 1 to about 30, alternatively from about 2 to about 20, or alternatively from about 2 to about 10; and the C3+ alkoxylating element may occur x1 times with the value of x1 ranging from about 0 to about 300, alternatively from about 2 to about 250, or alternatively from about 10 to about 200, per 100 g of humus material. As will be appreciated by one of skill in the art, and with the help of this disclosure, x1, y and z cannot all be 0 at the same time.

Without wishing to be limited by theory, the functional groups of the humus material may act as the nucleophile in the alkoxylation reaction in the presence of a strong base, thereby attacking the C3+ cyclic ether ring (e.g., the cyclic ether ring of the compound characterized by Structure III) at the least substituted carbon atom. Further, without wishing to be limited by theory, it is expected that the alkoxylation reaction between the humus material and the C3+ cyclic ether in the presence of a strong base will yield the compound characterized by Structure VII, due both to the presence of the strong base catalyst and to major steric hinderance between the very bulky humus material and the alkyl chain (e.g., (CH₂)ₙCH₃) present in the C3+ cyclic ether compound characterized by Structure III. While unlikely, it might be possible that a small amount of a compound characterized by Structure VIII would form during the alkoxylation of the humus material in the presence of a strong base.

In an embodiment, the AHMs obtained as previously described herein by using a strong base catalyst may comprise a compound characterized by Structure VIII in an amount of less than about 10 wt. %, alternatively less than about 9 wt. %, alternatively less than about 8 wt. %, alternatively less than about 7 wt. %, alternatively less than about 6 wt. %, alternatively less than about 5 wt. %, alternatively less than about 4 wt. %, alternatively less than about 3 wt. %, alternatively less than about 2 wt. %, alternatively less than about 1 wt. %, alternatively less than about 0.1 wt. %, alternatively less than about 0.01 wt. %, alternatively less than about 0.001 wt. %, alternatively less than about 0.0001 wt. %, based on the total weight of the AHM.

Without wishing to be limited by theory, in the presence of a strong acid catalyst, the C3+ cyclic ether ring deprotonates the strong acid, thereby creating a protonated C3+ cyclic ether ring intermediate having a positive charge that is delocalized between the 0 atom of the cyclic ether ring and the most substituted carbon atom adjacent to the 0 atom of the cyclic ether ring, thereby enabling the functional groups of the humus material to act as the nucleophile in the alkoxylation reaction, and attack the C3+ cyclic ether ring (e.g., the cyclic ether ring of the compound characterized by Structure III) at the most substituted carbon atom. Further, without wishing to be limited by theory, it is expected that the alkoxylation reaction between the humus material and the C3+ cyclic ether in the presence of a strong acid will yield the compound characterized by Structure VIII, due to the presence of the strong acid catalyst. While unlikely, it might be possible that a small amount of a compound characterized by Structure VII would form during the alkoxylation of the humus material in the presence of a strong acid.

In an embodiment, the AHMs obtained as previously described herein by using a strong acid catalyst may comprise a compound characterized by Structure VII in an amount of less than about 10 wt. %, alternatively less than about 9 wt. %, alternatively less than about 8 wt. %, alternatively less than about 7 wt. %, alternatively less than about 6 wt. %, alternatively less than about 5 wt. %, alternatively less than about 4 wt. %, alternatively less than about 3 wt. %, alternatively less than about 2 wt. %, alternatively less than about 1 wt. %, alternatively less than about 0.1 wt. %, alternatively less than about 0.01 wt. %, alternatively less than about 0.001 wt. %, alternatively less than about 0.0001 wt. %, based on the total weight of the AHM.

As will be appreciated by one of skill in the art, and with the help of this disclosure, an AHM obtained by using a strong acid catalyst may be combined with an AHM obtained by using a strong base catalyst, as it may be desirable to modulate the properties (e.g., solubility, melting point, thermal stability, etc.) of the AHM to be used in further applications.

In an embodiment, the AHM comprises a multi-branched structure, wherein each branch comprises repeating alkoxy units, such as for example repeating C3+ cyclic ether units (e.g., C3+ epoxide unit, oxetane unit) and/or repeating ethoxy units, as shown in Structure VII and/or Structure VIII. For example, each branch of the AHM is represented in Structure VII by each of the x C3+ alkoxylating elements, by each of the y ethoxylating elements, or by each of the z C3+ alkoxylating elements. For example, each branch of the AHM is represented in Structure VIII by each of the x1 C3+ alkoxylating elements, by each of the y ethoxylating elements, or by each of the z C3+ alkoxylating elements. In an embodiment, the branch of an AHM may comprise a C3+ alkoxylating element of Structure VII, an ethoxylating element, or combinations thereof. In an embodiment, the branch of an AHM may comprise a C3+ alkoxylating element of Structure VIII, an ethoxylating element, or combinations thereof.

In an embodiment, an AHM obtained by using a strong base catalyst may comprise a repeating C3+ cyclic ether unit (e.g., C3+ epoxide unit) as shown in Structure VIII in an amount of less than about 10 wt. %, alternatively less than about 9 wt. %, alternatively less than about 8 wt. %, alternatively less than about 7 wt. %, alternatively less than about 6 wt. %, alternatively less than about 5 wt. %, alternatively less than about 4 wt. %, alternatively less than about 3 wt. %, alternatively less than about 2 wt. %, alternatively less than about 1 wt. %, alternatively less than about 0.1 wt. %, alternatively less than about 0.01 wt. %, alternatively less than about 0.001 wt. %, alternatively less than about 0.0001 wt. %, based on the total weight of the AHM obtained by using a strong base catalyst.

In an embodiment, an AHM obtained by using a strong acid catalyst may comprise a repeating C3+ cyclic ether unit (e.g., C3+ epoxide unit) as shown in Structure VII in an amount of less than about 10 wt. %, alternatively less than about 9 wt. %, alternatively less than about 8 wt. %, alternatively less than about 7 wt. %, alternatively less than about 6 wt. %, alternatively less than about 5 wt. %, alternatively less than about 4 wt. %, alternatively less than about 3 wt. %, alternatively less than about 2 wt. %, alternatively less than about 1 wt. %, alternatively less than about 0.1 wt. %, alternatively less than about 0.01 wt. %, alternatively less than about 0.001 wt. %, alternatively less than about 0.0001 wt. %, based on the total weight of the AHM obtained by using a strong acid catalyst.

As will be apparent to one of skill in the art, and with the help of this disclosure, each of the x C3+ alkoxylating elements and/or C3+ alkoxylating branches of Structure VII may independently comprise lengths (e.g., numbers (m) of cyclic ether units) that may be the same or different when compared to the lengths (e.g., numbers (m) of cyclic ether units) of the other C3+ alkoxylating elements (e.g., C3+ alkoxylating branches). For example, one or more of the C3+ alkoxylating elements (e.g., C3+ alkoxylating branches) of Structure VII may comprise m=5 C3+ cyclic ether units; one or more of the C3+ alkoxylating elements (e.g., C3+ alkoxylating branches) may comprise m=4 C3+ cyclic ether units; one or more of the C3+ alkoxylating elements (e.g., C3+ alkoxylating branches) may comprise m=8 C3+ cyclic ether units; etc. Similarly, when oxetane as characterized by Structure II is used in the alkoxylation reaction, each of the z C3+ alkoxylating elements and/or C3+ alkoxylating branches of Structure VII and/or Structure VIII may independently comprise lengths (e.g., numbers (q) of oxetane units) that may be the same or different when compared to the lengths (e.g., numbers (q) of oxetane units) of the other C3+ alkoxylating elements (e.g., C3+ alkoxylating branches). For example, one or more of the z C3+ alkoxylating elements (e.g., C3+ alkoxylating branches) of Structure VII and/or Structure VIII may comprise q=5 oxetane units; one or more of the z C3+ alkoxylating elements (e.g., C3+ alkoxylating branches) may comprise q=4 oxetane units; one or more of the z C3+ alkoxylating elements (e.g., C3+ alkoxylating branches) may comprise q=8 oxetane units; etc. Similarly, when ethylene oxide is used in the alkoxylation reaction along with the C3+ cyclic ether (e.g., y 0), each of the y ethoxylating elements and/or ethoxylating branches of Structure VII and/or Structure VIII may independently comprise lengths (e.g., numbers (p) of ethoxy units) that may be the same or different when compared to the lengths (e.g., numbers (p) of ethoxy units) of the other ethoxylating elements (e.g., ethoxylating branches). For example, one or more of the ethoxylating elements (e.g., ethoxylating branches) of Structure VII and/or Structure VIII may comprise p=5 ethoxy units; one or more of the ethoxylating elements (e.g., ethoxylating branches) may comprise p=4 ethoxy units; one or more of the ethoxylating elements (e.g., ethoxylating branches) may comprise p=8 ethoxy units; etc.

As will be apparent to one of ordinary skill in the art, and with the help of this disclosure, more than one type of C3+ cyclic ether may be used in the same alkoxylation reaction of the humus material, and as such one or more of the x C3+ alkoxylating elements (e.g., C3+ alkoxylating branches) of Structure VII and/or one or more of the x1 C3+ alkoxylating elements (e.g., C3+ alkoxylating branches) of Structure VIII may comprise different types of cyclic ether units (e.g., propylene oxide, butylene oxide, pentylene oxide, etc.). For example, some of the C3+ alkoxylating elements (e.g., C3+ alkoxylating branches) of Structure VII and/or Structure VIII may comprise only one type of cyclic ether unit (e.g., propylene oxide); other C3+ alkoxylating elements (e.g., C3+ alkoxylating branches) of Structure VII and/or Structure VIII may comprise only one type of a different type of cyclic ether unit (e.g., butylene oxide); other C3+ alkoxylating elements (e.g., C3+ alkoxylating branches) of Structure VII and/or Structure VIII may comprise only one type of another type of cyclic ether unit (e.g., oxetane); one or more of the C3+ alkoxylating elements (e.g., C3+ alkoxylating branches) of Structure VII and/or Structure VIII may comprise two types of cyclic ether units (e.g., propylene oxide and butylene oxide); one or more of the C3+ alkoxylating elements (e.g., C3+ alkoxylating branches) of Structure VII and/or Structure VIII may comprise three types of cyclic ether units (e.g., propylene oxide, butylene oxide, and oxetane); etc. Similarly, when ethylene oxide is used in the alkoxylation reaction along with the C3+ cyclic ether (e.g., y 0), each of the alkoxylating elements (e.g., alkoxylating branches) of Structure VII and/or Structure VIII (e.g., C3+ alkoxylating element, ethoxylating element) may independently comprise both ethoxy units and C3+ cyclic ether units.

In an embodiment, when more than one type of alkoxylating agent (e.g., C3+ cyclic ether, propylene oxide, butylene oxide, pentylene oxide, oxetane, ethylene oxide, etc.) is used during the alkoxylation reaction of the humus material, all alkoxylating agents (e.g., C3+ cyclic ether, propylene oxide, butylene oxide, pentylene oxide, oxetane, ethylene oxide, etc.) may be added into the reaction vessel at the same time. In an alternative embodiment, the alkoxylating agents (e.g., C3+ cyclic ether, propylene oxide, butylene oxide, pentylene oxide, oxetane, ethylene oxide, etc.) may be added into the reaction vessel at different times. In some embodiments, the alkoxy units may form new alkoxylated elements/branches, or may extend already existing alkoxylated elements/branches. In yet other embodiments, the humus material may be alkoxylated with one type of alkoxylating agent (e.g., C3+ cyclic ether, propylene oxide, butylene oxide, pentylene oxide, oxetane, ethylene oxide, etc.) and then recovered as a first AHM, and the first AHM may be used as the humus material in a subsequent alkoxylation reaction with a different type of alkoxylating agent (e.g., C3+ cyclic ether, propylene oxide, butylene oxide, pentylene oxide, oxetane, ethylene oxide, etc.) and then recovered as a second AHM. In such embodiments, the second AHM may comprise alkoxylated elements/branches of the first AHM, alkoxylated elements/branches that were newly formed in the subsequent alkoxylation reaction, and alkoxylated elements/branches that were formed by adding alkoxy units to the alkoxylated elements/branches of the first AHM. As will be appreciated by one of skill in the art, and with the help of this disclosure, an AHM produced in the presence of a strong acid catalyst may be used as the humus material in a subsequent alkoxylation reaction that may take place in the presence of a strong base catalyst. Similarly, as will be appreciated by one of skill in the art, and with the help of this disclosure, an AHM produced in the presence of a strong base catalyst may be used as the humus material in a subsequent alkoxylation reaction that may take place in the presence of a strong acid catalyst.

In an embodiment, the structure of the compound characterized by Structure VII and/or the structure of the compound characterized by Structure VIII may be confirmed by running structure analysis tests. Nonlimiting examples of structure analysis tests suitable for use in the present disclosure include ash analysis for mineral content; elemental ash analysis; elemental analysis for C, H, O, N, S, which could also provide some information regarding the ratio of different alkoxy units in the AHM, such as for example the ratio of propylene oxide or propoxy units to ethoxy units in the AHM, in the case of an alkoxylation reaction where both propylene oxide and ethylene oxide are used; infrared or IR spectroscopy, which could provide information with respect to carboxylic groups differences between the humus material and the AHM, as well as identify the presence of different alkoxy units in the AHM, such as for example the propoxy units and ethoxy units in the AHM; ultraviolet-visible or UV-Vis spectroscopy which could provide information regarding the presence of alkoxy units in the AHM; nuclear magnetic resonance or NMR spectroscopy for AHMs soluble in D₂O (i.e., deuterated water) and/or CDCl₃ (deuterated chloroform), to identify the presence of different alkoxy units in the AHM, such as for example the propoxy units and ethoxy units in the AHM, as well as their ratios with respect to each other; thermogravimetric analysis or TGA for investigating the AHM profile loss of weight versus temperature, i.e., AHM thermal stability; differential thermal analysis or DTA to record the exotherm thermograms or the endotherm thermograms; differential scanning calorimetry or DSC; gel permeation chromatography and low-angle laser light scattering to determine the MW of the AHMs; and the like.

In an embodiment, the reaction mixture excludes ethylene oxide. In an embodiment, the reaction mixture does not contain a material amount of ethylene oxide. In an embodiment, the reaction mixture comprises ethylene oxide in an amount of less than about 1 wt. %, alternatively less than about 0.1 wt. %, alternatively less than about 0.01 wt. %, alternatively less than about 0.001 wt. %, alternatively less than about 0.0001 wt. %, alternatively less than about 0.00001 wt. %, or alternatively less than about 0.000001 wt. %, based on the total weight of the reaction mixture. In such embodiment, referring to the AHM characterized by Structure VII and/or to the AHM characterized by Structure VIII, y=0. In such embodiment, the AHM characterized by Structure VII and/or the AHM characterized by Structure VIII comprises a CAHM. In such embodiment, the AHM characterized by Structure VII comprises a compound characterized by Structure IX (e.g., a CAHM), and/or the AHM characterized by Structure VIII comprises a compound characterized by Structure X (e.g., a CAHM):

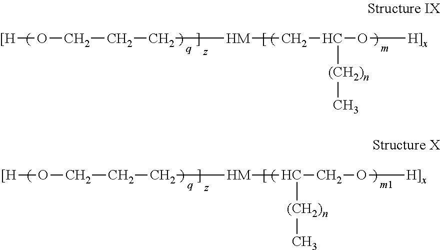

where HM represents the humus material; the repeating methylene (—CH₂—) unit may occur n times with the value of n ranging from about 0 to about 3, alternatively from about 0 to about 2, or alternatively from about 0 to about 1, as previously described for the C3+ cyclic ether compound characterized by Structure III; the repeating C3+ cyclic ether unit that originates from the C3+ cyclic ether (e.g., C3+ epoxide) in the presence of a strong base catalyst may occur m times with the value of m ranging from about 1 to about 30, alternatively from about 2 to about 20, or alternatively from about 2 to about 10; the repeating C3+ cyclic ether unit that originates from the C3+ cyclic ether (e.g., C3+ epoxide) in the presence of a strong acid catalyst may occur m1 times with the value of m1 ranging from about 1 to about 30, alternatively from about 2 to about 20, or alternatively from about 2 to about 10; the C3+ alkoxylating element may occur x times with the value of x ranging from about 0 to about 300, alternatively from about 2 to about 250, or alternatively from about 10 to about 200, per 100 g of humus material; the C3+ alkoxylating element may occur x1 times with the value of x1 ranging from about 0 to about 300, alternatively from about 2 to about 250, or alternatively from about 10 to about 200, per 100 g of humus material; the repeating oxetane unit (e.g., when the C3+ cyclic ether used in the alkoxylation comprises oxetane as characterized by Structure II) may occur q times with the value of q ranging from about 1 to about 30, alternatively from about 2 to about 20, or alternatively from about 2 to about 10; and the C3+ alkoxylating element may occur z times with the value of z ranging from about 0 to about 300, alternatively from about 1 to about 250, or alternatively from about 2 to about 200, per 100 g of humus material. As will be appreciated by one of skill in the art, and with the help of this disclosure, x and z cannot both be 0 at the same time. Similarly, as will be appreciated by one of skill in the art, and with the help of this disclosure, x1 and z cannot both be 0 at the same time.

In an embodiment, the CAHM characterized by Structure IX comprises a propoxylated humus material characterized by Structure XI, a propoxylated/butoxylated humus material characterized by Structure XII, a propoxylated/pentoxylated humus material characterized by Structure XIII, and the like, or combinations thereof. As will be appreciated by one of skill in the art, and with the help of this disclosure, the alkoxylation of a humus material with oxetane results in a propoxylated humus material. Further, as will be appreciated by one of skill in the art, and with the help of this disclosure, a propoxylated humus material may comprise oxetane units, propoxy units that originate in an alkoxylating agent comprising propylene oxide as characterized by Structure IV, or combinations thereof.

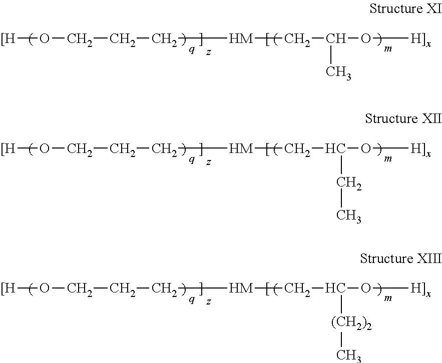

In an embodiment, the CAHM characterized by Structure X comprises a propoxylated humus material characterized by Structure XIV, a propoxylated/butoxylated humus material characterized by Structure XV, a propoxylated/pentoxylated humus material characterized by Structure XVI, and the like, or combinations thereof.

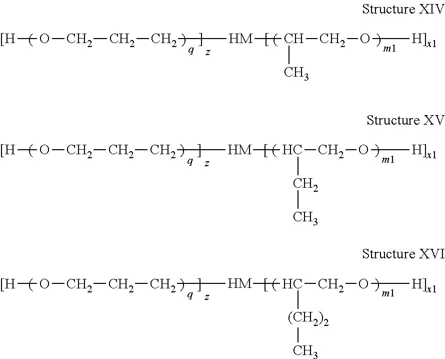

In an embodiment, the reaction mixture excluding ethylene oxide further excludes oxetane as characterized by Structure II. In such embodiment, the reaction mixture does not contain a material amount of oxetane. In such embodiment, the reaction mixture comprises oxetane in an amount of less than about 1 wt. %, alternatively less than about 0.1 wt. %, alternatively less than about 0.01 wt. %, alternatively less than about 0.001 wt. %, alternatively less than about 0.0001 wt. %, alternatively less than about 0.00001 wt. %, or alternatively less than about 0.000001 wt. %, based on the total weight of the reaction mixture. In such embodiment, referring to the CAHM characterized by Structure IX and/or to the CAHM characterized by Structure X, z=0. In such embodiment, the CAHM characterized by Structure IX comprises a compound characterized by Structure XVII, and/or the CAHM characterized by Structure X comprises a compound characterized by Structure XVIII:

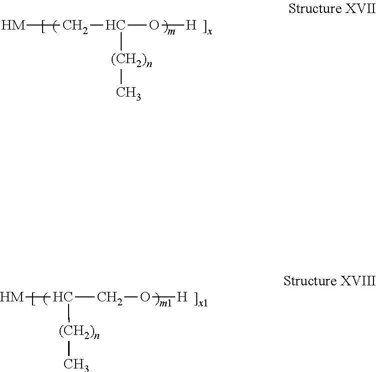

where HM represents the humus material; the repeating methylene (—CH₂—) unit may occur n times with the value of n ranging from about 0 to about 3, alternatively from about 0 to about 2, or alternatively from about 0 to about 1, as previously described for the C3+ cyclic ether compound characterized by Structure III; the repeating C3+ cyclic ether unit that originates from the C3+ cyclic ether in the presence of a strong base catalyst may occur m times with the value of m ranging from about 1 to about 30, alternatively from about 2 to about 20, or alternatively from about 2 to about 10; the repeating C3+ cyclic ether unit that originates from the C3+ cyclic ether (e.g., C3+ epoxide) in the presence of a strong acid catalyst may occur m1 times with the value of m1 ranging from about 1 to about 30, alternatively from about 2 to about 20, or alternatively from about 2 to about 10; the C3+ alkoxylating element may occur x times with the value of x ranging from about 1 to about 300, alternatively from about 2 to about 250, or alternatively from about 10 to about 200, per 100 g of humus material; the C3+ alkoxylating element may occur x1 times with the value of x1 ranging from about 1 to about 300, alternatively from about 2 to about 250, or alternatively from about 10 to about 200, per 100 g of humus material.

In an embodiment, the CAHM characterized by Structure XVII comprises a propoxylated humus material characterized by Structure XIX, a butoxylated humus material characterized by Structure XX, a pentoxylated humus material characterized by Structure XXI, and the like, or combinations thereof.

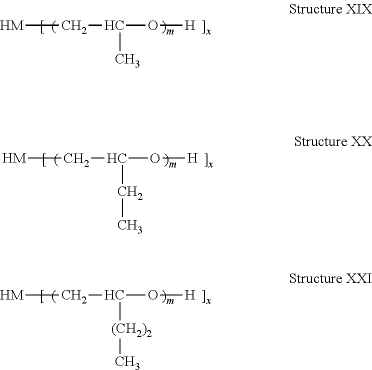

In an embodiment, the CAHM characterized by Structure XVIII comprises a propoxylated humus material characterized by Structure XXII, a butoxylated humus material characterized by Structure XXIII, a pentoxylated humus material characterized by Structure XXIV, and the like, or combinations thereof.

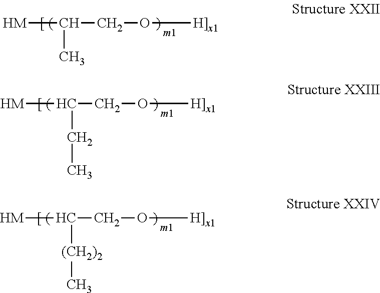

In an embodiment, the reaction mixture excluding ethylene oxide further excludes an epoxide (e.g., C3+ epoxide) compound characterized by Structure III. In such embodiment, the reaction mixture does not contain a material amount of an epoxide (e.g., C3+ epoxide) compound characterized by Structure III. In such embodiment, the reaction mixture comprises an epoxide (e.g., C3+ epoxide) compound characterized by Structure III in an amount of less than about 1 wt. %, alternatively less than about 0.1 wt. %, alternatively less than about 0.01 wt. %, alternatively less than about 0.001 wt. %, alternatively less than about 0.0001 wt. %, alternatively less than about 0.00001 wt. %, or alternatively less than about 0.000001 wt. %, based on the total weight of the reaction mixture. In such embodiment, referring to the CAHM characterized by Structure IX, x=0. In such embodiment, referring to the CAHM characterized by Structure X, x1=0. In such embodiment, the CAHM characterized by Structure IX and/or the CAHM characterized by Structure X comprise a propoxylated humus material characterized by Structure XXV:

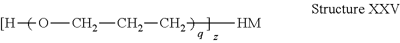

where HM represents the humus material; the repeating oxetane unit (e.g., when the C3+ cyclic ether used in the alkoxylation comprises oxetane as characterized by Structure II) may occur q times with the value of q ranging from about 1 to about 30, alternatively from about 2 to about 20, or alternatively from about 2 to about 10; and the C3+ alkoxylating element may occur z times with the value of z ranging from about 1 to about 300, alternatively from about 1 to about 250, or alternatively from about 2 to about 200, per 100 g of humus material.

In an embodiment, the reaction mixture comprises a strong base catalyst and ethylene oxide along with the C3+ cyclic ether, as previously described herein. In such embodiment, the AHM characterized by Structure VII comprises a propoxylated/ethoxylated humus material characterized by Structure XXVI, a butoxylated/propoxylated/ethoxylated humus material characterized by Structure XXVII, a pentoxylated/propoxylated/ethoxylated humus material characterized by Structure XXVIII, and the like, or combinations thereof.

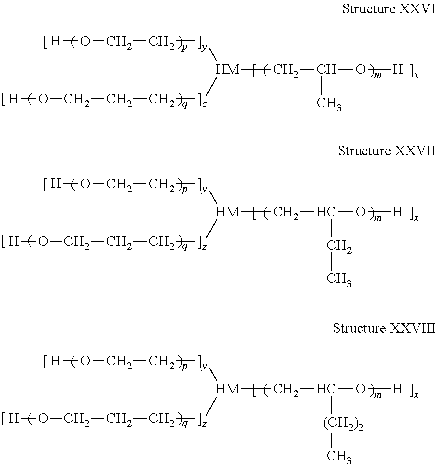

In an embodiment, the reaction mixture comprises a strong acid catalyst and ethylene oxide along with the C3+ cyclic ether, as previously described herein. In such embodiment, the AHM characterized by Structure VIII comprises a propoxylated/ethoxylated humus material characterized by Structure XXIX, a butoxylated/propoxylated/ethoxylated humus material characterized by Structure XXX, a pentoxylated/propoxylated/ethoxylated humus material characterized by Structure XXXI, and the like, or combinations thereof.

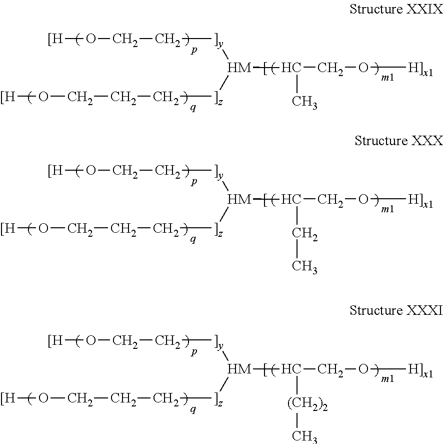

In an embodiment, the reaction mixture excludes oxetane. In an embodiment, the reaction mixture does not contain a material amount of oxetane. In an embodiment, the reaction mixture comprises oxetane in an amount of less than about 1 wt. %, alternatively less than about 0.1 wt. %, alternatively less than about 0.01 wt. %, alternatively less than about 0.001 wt. %, alternatively less than about 0.0001 wt. %, alternatively less than about 0.00001 wt. %, or alternatively less than about 0.000001 wt. %, based on the total weight of the reaction mixture. In such embodiment, referring to the AHM characterized by Structure VII and/or to the AHM characterized by Structure VIII, z=0. In such embodiment, the AHM characterized by Structure VII comprises a compound characterized by Structure XXXII (e.g., a CAHM), and/or the AHM characterized by Structure VIII comprises a compound characterized by Structure XXXIII (e.g., a CAHM):

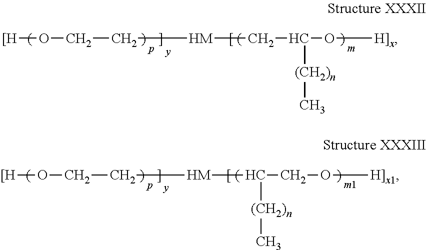

where HM represents the humus material; the repeating methylene (—CH₂—) unit may occur n times with the value of n ranging from about 0 to about 3, alternatively from about 0 to about 2, or alternatively from about 0 to about 1, as previously described for the C3+ cyclic ether compound characterized by Structure III; the repeating C3+ cyclic ether unit that originates from the C3+ cyclic ether in the presence of a strong base catalyst may occur m times with the value of m ranging from about 1 to about 30, alternatively from about 2 to about 20, or alternatively from about 2 to about 10; the repeating C3+ cyclic ether unit that originates from the C3+ cyclic ether (e.g., C3+ epoxide) in the presence of a strong acid catalyst may occur m1 times with the value of m1 ranging from about 1 to about 30, alternatively from about 2 to about 20, or alternatively from about 2 to about 10; the C3+ alkoxylating element may occur x times with the value of x ranging from about 1 to about 300, alternatively from about 2 to about 250, or alternatively from about 10 to about 200, per 100 g of humus material; the C3+ alkoxylating element may occur x1 times with the value of x1 ranging from about 1 to about 300, alternatively from about 2 to about 250, or alternatively from about 10 to about 200, per 100 g of humus material; the repeating ethoxy unit (e.g., when ethylene oxide is used in the alkoxylation along with the C3+ cyclic ether) may occur p times with the value of p ranging from about 1 to about 30, alternatively from about 2 to about 20, or alternatively from about 2 to about 10; and the ethoxylating element may occur y times with the value of y ranging from about 1 to about 200, alternatively from about 1 to about 150, or alternatively from about 2 to about 100, per 100 g of humus material.

In an embodiment, the reaction mixture comprises a strong base catalyst and ethylene oxide along with the C3+ cyclic ether, as previously described herein. In such embodiment, the CAHM characterized by Structure XXXII comprises a propoxylated/ethoxylated humus material characterized by Structure XXXIV, a butoxylated/ethoxylated humus material characterized by Structure XXXV, a pentoxylated/ethoxylated humus material characterized by Structure XXXVI, and the like, or combinations thereof.

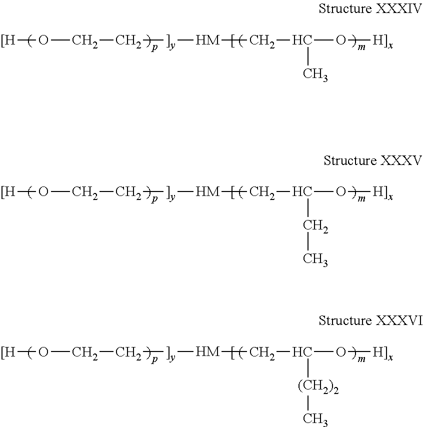

In an embodiment, the reaction mixture comprises a strong acid catalyst and ethylene oxide along with the C3+ cyclic ether, as previously described herein. In such embodiment, the CAHM characterized by Structure XXXIII comprises a propoxylated/ethoxylated humus material characterized by Structure XXXVII, a butoxylated/ethoxylated humus material characterized by Structure XXXVIII, a pentoxylated/ethoxylated humus material characterized by Structure XXXIX, and the like, or combinations thereof.

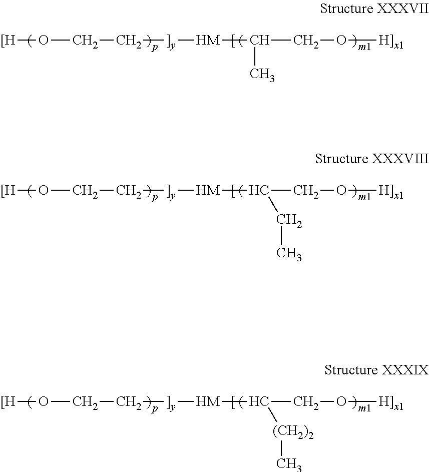

In an embodiment, the reaction mixture excluding oxetane further excludes an epoxide (e.g., C3+ epoxide) compound characterized by Structure III. In such embodiment, the reaction mixture does not contain a material amount of an epoxide (e.g., C3+ epoxide) compound characterized by Structure III. In such embodiment, the reaction mixture comprises an epoxide (e.g., C3+ epoxide) compound characterized by Structure III in an amount of less than about 1 wt. %, alternatively less than about 0.1 wt. %, alternatively less than about 0.01 wt. %, alternatively less than about 0.001 wt. %, alternatively less than about 0.0001 wt. %, alternatively less than about 0.00001 wt. %, or alternatively less than about 0.000001 wt. %, based on the total weight of the reaction mixture. In such embodiment, referring to the AHM characterized by Structure VII, x=0 and z=0. In such embodiment, referring to the AHM characterized by Structure VIII, x1=0 and z=0. In such embodiment, the AHM characterized by Structure VII and/or the AHM characterized by Structure VIII comprises an EHM. In an embodiment, the EHM comprises a compound characterized by Structure XL:

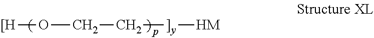

where HM represents the humus material; the repeating ethoxy unit may occur p times with the value of p ranging from about 1 to about 30, alternatively from about 2 to about 20, or alternatively from about 2 to about 10; and the ethoxylating element may occur y times with the value of y ranging from about 1 to about 200, alternatively from about 1 to about 150, or alternatively from about 2 to about 100, per 100 g of humus material.

In an embodiment, the AHMs may be a liquid when the weight ratio of alkoxylating agent to humus material ranges from about 2:1 to about 15:1. In another embodiment, the AHMs may be a greasy wax when the weight ratio of alkoxylating agent to humus material is from about 15:1 to about 20:1. In yet another embodiment, the AHMs may be a waxy solid when the weight ratio of alkoxylating agent to humus material is from about 20:1 to about 30:1. In still yet another embodiment, the AHMs may be a solid when the weight ratio of alkoxylating agent to humus material ranges from about 30:1 to about 50:1.

In an embodiment, an AHM suitable for use as a FLA in a WSF of the type disclosed herein may have a weight ratio of alkoxylating agent to humus material in the range of from about 10:1 to about 40:1, alternatively from about 15:1 to about 35:1, alternatively from about 20:1 to about 30:1, or alternatively from about 20:1 to about 25:1.

Generally, the AHMs may be soluble in polar solvents such as water and methanol and insoluble in alkanes, hexane, pentane, and the like. Without wishing to be limited by theory, the higher the degree of alkoxylation of the AHMs (e.g., the extent of the chemical modification of the humus materials), the higher the solubility of the AHMs in polar solvents. The AHMs may also be soluble to some extent (e.g., slightly soluble) in aromatic hydrocarbons, and temperatures above the ambient temperature increase the solubility of AHMs in aromatic hydrocarbons. In an embodiment, the liquid AHMs may be slightly soluble in water and xylene. In an embodiment, the greasy wax AHMs may be slightly soluble in dimethyl formamide, and soluble in water and xylene. In an embodiment, the waxy solid AHMs may be soluble in dimethyl formamide and xylene, and very soluble in water. In an embodiment, the solid AHMs may be very soluble in dimethyl formamide, xylene, and water. For the purposes of the disclosure herein, “insoluble” refers to a solubility of less than 1.0 g/L in a particular solvent; “slightly soluble” refers to a solubility of from about 1.0 g/L to about 2.0 g/L in a particular solvent; “soluble” refers to a solubility of from about 2.0 g/L to about 20.0 g/L in a particular solvent; and “very soluble” refers to a solubility of equal to or greater than about 20.0 g/L in a particular solvent; wherein all solubility values are given at room temperature, unless otherwise noted.

In an embodiment, the AHM may have a temperature stability of from about 25° F. to about 500° F., alternatively from about 25° F. to about 450° F., or alternatively from about 25° F. to about 350° F. Generally, the temperature stability of a substance/compound (e.g., AHM) represents a temperature range where such substance/compound is thermally stable, e.g., the chemical composition of such substance/compound does not change. In an embodiment, the temperature or thermal stability corresponds to the operating conditions of the WSF, for example the ambient downhole or bottom hole temperature associated with drilling operations using a water based drilling fluid comprising an AHM. The temperature stability of the AHM may be determined by TGA. For purposes of the disclosure herein, the AHM may be considered thermally stable if the AHM loses less than about 5 wt. %, alternatively less than about 2 wt. %, or alternatively less than about 1 wt. %, in a TGA experiment at a temperature of from about 25° F. to about 500° F., alternatively from about 25° F. to about 450° F., or alternatively from about 25° F. to about 350° F. Without wishing to be limited by theory, the AHMs owe their wide temperature stability range to the temperature stability of the humus materials used for preparing the AHMs.

In an embodiment, the AHM may be included within the WSF in a suitable amount. In an embodiment, the AHM is present within the WSF in an amount of from about 0.25 wt. % to about 5 wt. %, alternatively from about 0.5 wt. % to about 4 wt. %, or alternatively from about 1 wt. % to about 3 wt. %, based on the total weight of the WSF.

In an embodiment, the WSF comprises an aqueous base fluid. Herein, an aqueous base fluid refers to a fluid having equal to or less than about 20 vol. %, 15 vol. %, 10 vol. %, 5 vol. %, 2 vol. %, or 1 vol. % of a non-aqueous fluid based on the total volume of the WSF. Aqueous base fluids that may be used in the WSF include any aqueous fluid suitable for use in subterranean applications, provided that the aqueous base fluid is compatible with the AHM (e.g., EHM and/or CAHM) used in the WSF. For example, the WSF may comprise water or a brine. In an embodiment, the base fluid comprises an aqueous brine. In such an embodiment, the aqueous brine generally comprises water and an inorganic monovalent salt, an inorganic multivalent salt, or both. The aqueous brine may be naturally occurring or artificially-created. Water present in the brine may be from any suitable source, examples of which include, but are not limited to, sea water, tap water, freshwater, water that is potable or non-potable, untreated water, partially treated water, treated water, produced water, city water, well-water, surface water, or combinations thereof. The salt or salts in the water may be present in an amount ranging from greater than about 0% by weight to a saturated salt solution, alternatively from about 1 wt. % to about 18 wt. %, or alternatively from about 2 wt. % to about 7 wt. %, by weight of the aqueous fluid. In an embodiment, the salt or salts in the water may be present within the base fluid in an amount sufficient to yield a saturated brine.

Nonlimiting examples of aqueous brines suitable for use in the present disclosure include chloride-based, bromide-based, phosphate-based or formate-based brines containing monovalent and/or polyvalent cations, salts of alkali and alkaline earth metals, or combinations thereof. Additional examples of suitable brines include, but are not limited to: NaCl, KCl, NaBr, CaCl₂, CaBr₂, ZnBr₂, ammonium chloride (NH₄Cl), potassium phosphate, sodium formate, potassium formate, cesium formate, ethyl formate, methyl formate, methyl chloro formate, triethyl orthoformate, trimethyl orthoformate, or combinations thereof. In an embodiment, the aqueous fluid comprises a brine. The brine may be present in an amount of from about 1 wt. % to about 99 wt. %, alternatively from about 25 wt. % to about 99 wt. %, or alternatively from about 40 wt. % to about 99 wt. %, based on the total weight of the WSF. Alternatively, the aqueous base fluid may comprise the balance of the WSF after considering the amount of the other components used.

The WSF may further comprise additional additives as deemed appropriate for improving the properties of the fluid. Such additives may vary depending on the intended use of the fluid in the wellbore. In an embodiment, the WSF further comprises one or more additives and is formulated for use as an aqueous based drilling fluid or mud, and in particular formulated as suitable for high temperature drilling operations. Examples of such additives include, but are not limited to viscosifying agents, viscosifiers, gelling agents, crosslinkers, suspending agents, clays, clay control agents, conventional fluid loss additives, dispersants, flocculants, surfactants, pH adjusting agents, bases, acids, pH buffers, mutual solvents, corrosion inhibitors, breaking agents, emulsifiers, relative permeability modifiers, lime, weighting agents, glass fibers, carbon fibers, conditioning agents, water softeners, foaming agents, proppants, salts, oxidation inhibitors, scale inhibitors, thinners, scavengers, gas scavengers, lubricants, friction reducers, antifoam agents, bridging agents, and the like, or combinations thereof. These additives may be introduced singularly or in combination using any suitable methodology and in amounts effective to produce the desired improvements in fluid properties. As will appreciated by one of skill in the art with the help of this disclosure, any of the components and/or additives used in the WSF have to be compatible with the AHM (e.g., EHM and/or CAHM) used in the WSF.

In an embodiment, the WSF further comprises a viscosifying agent or a viscosifier. Generally, when added to a fluid, a viscosifying agent increases the viscosity of such fluid. For example, a viscosifying agent may improve the ability of a drilling fluid (e.g., an aqueous based drilling fluid comprising the AHM and a viscosifying agent) to remove cuttings from a wellbore and to suspend cuttings and weighting agents during periods of non-circulation by increasing the viscosity of the drilling fluid.

In an embodiment, the viscosifying agent is comprised of a naturally-occurring material. Alternatively, the viscosifying agent comprises a synthetic material. Alternatively, the viscosifying agent comprises a mixture of a naturally-occurring and synthetic material.

In an embodiment, a viscosifying agent comprises viscosifying polymers, gelling agents, polyamide resins, polycarboxylic acids, fatty acids, soaps, clays, derivatives thereof, or combinations thereof. Herein the disclosure may refer to a polymer and/or a polymeric material. It is to be understood that the terms polymer and/or polymeric material herein are used interchangeably and are meant to each refer to compositions comprising at least one polymerized monomer in the presence or absence of other additives traditionally included in such materials. Examples of polymeric materials suitable for use as part of the viscosifying agent include, but are not limited to homopolymers, random, block, graft, star- and hyper-branched polyesters, copolymers thereof, derivatives thereof, or combinations thereof. The term “derivative” herein is defined to include any compound that is made from one or more of the viscosifying agents, for example, by replacing one atom in the viscosifying agent with another atom or group of atoms, rearranging two or more atoms in the viscosifying agent, ionizing one of the viscosifying agents, or creating a salt of one of the viscosifying agents. The term “copolymer” as used herein is not limited to the combination of two polymers, but includes any combination of any number of polymers, e.g., graft polymers, terpolymers, and the like.

In an embodiment, the viscosifying agent comprises a viscosifying polymer. In an embodiment, the viscosifying polymer may be used in uncrosslinked form. In an alternative embodiment, the viscosifying polymer may be a crosslinked polymer.

Nonlimiting examples of viscosifying polymers suitable for use in the present disclosure include polysaccharides, guar, locust bean gum, Karaya gum, gum tragacanth, hydroxypropyl guar (HPG), carboxymethyl guar (CMG), carboxymethyl hydroxypropyl guar (CMHPG), hydrophobically modified guars, high-molecular weight polysaccharides composed of mannose and galactose sugars, heteropolysaccharides obtained by the fermentation of starch-derived sugars, xanthan gum, diutan, welan, gellan, scleroglucan, chitosan, dextran, substituted or unsubstituted galactomannans, starch, cellulose, cellulose ethers, carboxycelluloses, carboxymethyl cellulose (CMC), hydroxyethyl cellulose (HEC), hydroxypropyl cellulose, carboxyalkylhydroxyethyl celluloses, carboxymethyl hydroxyethyl cellulose (CMHEC), methyl cellulose, polyacrylic acid (PAC), sodium polyacrylate, polyacrylamide (PAM), partially hydrolyzed polyacrylamide (PHPA), polymethacrylamide, poly(acrylamido-2-methyl-propane sulfonate), polysodium-2-acrylamide-3-propylsulfonate, polyvinyl alcohol, copolymers of acrylamide and poly(acrylamido-2-methyl-propane sulfonate), terpolymers of poly(acrylamido-2-methyl-propane sulfonate), acrylamide and vinylpyrrolidone or itaconic acid, derivatives thereof, and the like, or combinations thereof.

In an embodiment, the viscosifying agent comprises a clay. Nonlimiting examples of clays suitable for use in the present disclosure include water swellable clays, bentonite, montmorillonite, attapulgite, kaolinite, metakaolin, laponite, hectorite, sepiolite, organophilic clays, amine-treated clays, and the like, or combinations thereof.

In an embodiment, the viscosifying agent comprises LGC-VI gelling agent, WG-31 gelling agent, WG-35 gelling agent, WG-36 gelling agent, GELTONE II viscosifier, TEMPERUS viscosifier, or combinations thereof. LGC-VI gelling agent is an oil suspension of a guar-based gelling agent specifically formulated for applications that require a super-concentrated slurry; WG-31, WG-35, and WG-36 gelling agents are guar-based gelling agents used as solids; GELTONE II viscosifier is an organophilic clay; and TEMPERUS viscosifier is a modified fatty acid; each of which is commercially available from Halliburton Energy Services.

In an embodiment, the viscosifying agents may be included within the WSF in a suitable amount. In an embodiment a viscosifying agent of the type disclosed herein may be present within the WSF in an amount of from about 0.01 wt. % to about 15 wt. %, alternatively from about 0.1 wt. % to about 10 wt. %, or alternatively from about 0.4 wt. % to about 5 wt. %, based on the total weight of the WSF.

In an embodiment, the WSF further comprises a crosslinker. In an embodiment, the WSF is an aqueous based drilling fluid comprising the AHM and a crosslinker. In an embodiment, the WSF is an aqueous based drilling fluid comprising the AHM, a viscosifying agent, and a crosslinker. Without wishing to be limited by theory, a crosslinker is a chemical compound or agent that enables or facilitates the formation of crosslinks, i.e., bonds that link polymeric chains to each other, with the end result of increasing the molecular weight of the polymer. When a fluid comprises a polymer (e.g., a viscosifying polymeric material), crosslinking such polymer generally leads to an increase in fluid viscosity (e.g., due to an increase in the molecular weight of the polymer), when compared to the same fluid comprising the same polymer in the same amount, but without being crosslinked. The presence of a crosslinker in a WSF comprising a viscosifying polymer may lead to a crosslinked fluid. For example, if the viscosity of the WSF comprising a viscosifying polymer is z, the viscosity of the crosslinked fluid may be at least about 2z, alternatively about 10z, alternatively about 20z, alternatively about 50z, or alternatively about 100z. Crosslinked fluids are thought to have a three dimensional polymeric structure that is better able to support solids, such as for example drill cuttings, when compared to the same WSF comprising the same polymer in the same amount, but without being crosslinked.

Nonlimiting examples of crosslinkers suitable for use in the present disclosure include polyvalent metal ions, aluminum ions, zirconium ions, titanium ions, antimony ions, polyvalent metal ion complexes, aluminum complexes, zirconium complexes, titanium complexes, antimony complexes, and boron compounds, borate, borax, boric acid, calcium borate, magnesium borate, borate esters, polyborates, polymer bound boronic acid, polymer bound borates, and the like, or combinations thereof.

Examples of commercially available crosslinkers include without limitation BC-140 crosslinker; BC-200 crosslinker; CL-23 crosslinker; CL-24 crosslinker; CL-28M crosslinker; CL-29 crosslinker; CL-31 crosslinker; CL-36 crosslinker; K-38 crosslinker; or combinations thereof. BC-140 crosslinker is a specially formulated crosslinker/buffer system; BC-200 crosslinker is a delayed crosslinker that functions as both crosslinker and buffer; CL-23 crosslinker is a delayed crosslinking agent that is compatible with CO₂; CL-24 crosslinker is a zirconium-ion complex used as a delayed temperature-activated crosslinker; CL-28M crosslinker is a water-based suspension crosslinker of a borate mineral; CL-29 crosslinker is a fast acting zirconium complex; CL-31 crosslinker is a concentrated solution of non-delayed borate crosslinker; CL-36 crosslinker is a new mixed metal crosslinker; K-38 crosslinker is a borate crosslinker; all of which are available from Halliburton Energy Services.

In an embodiment, the crosslinker may be included within the WSF in a suitable amount. In an embodiment a crosslinker of the type disclosed herein may be present within the WSF in an amount of from about 10 parts per million (ppm) to about 500 ppm, alternatively from about 50 ppm to about 300 ppm, or alternatively from about 100 ppm to about 200 ppm, based on the total weight of the WSF.

In an embodiment, the WSF comprises an EHM, a viscosifying agent, and an aqueous base fluid. For example, the WSF may comprise 1 wt. % ethoxylated CARBONOX filtration control agent, 10 wt. % PHPA, and the balance comprises a KCl brine, based on the total weight of the WSF. In an embodiment, the weight ratio of ethylene oxide to CARBONOX filtration control agent used for preparing the ethoxylated CARBONOX filtration control agent is about 25:1.

In an alternative embodiment, the WSF comprises a CAHM, a viscosifying agent, and an aqueous base fluid. For example, the WSF may comprise 2 wt. % propoxylated lignite, 10 wt. % xanthan gum, and the balance comprises a KCl brine, based on the total weight of the WSF. In such embodiment, the propoxylated lignite is characterized by Structure XIX, wherein the humus material is lignite; the value of m is about 25; the value of x is about 1; and the weight ratio of propylene oxide as characterized by Structure IV to lignite used for preparing the propoxylated lignite is about 25:1.

In yet another embodiment, the WSF comprises an AHM and an aqueous base fluid, and optionally a viscosifying agent and/or a crosslinker. For example, the WSF may comprise 1 wt. % propoxylated/ethoxylated CARBONOX filtration control agent, and the balance comprises a KCl brine, based on the total weight of the WSF. In such embodiment, the propoxylated/ethoxylated CARBONOX filtration control agent is characterized by Structure XXXIV, wherein the humus material is CARBONOX filtration control agent, the value of m is about 2, the value of x is about 15, the value of p is about 1.2, the value of y is about 10; and the weight ratio of alkoxylating agent to lignite used for preparing the propoxylated/ethoxylated lignite is about 25:1, wherein the alkoxylating agent comprises ethylene oxide and propylene oxide as characterized by Structure IV in a weight ratio of ethylene oxide to propylene oxide of about 1.5:1.

In an embodiment, the WSF composition comprising an AHM (e.g., EHM and/or CAHM) may be prepared using any suitable method or process. The components of the WSF (e.g., EHM and/or CAHM, aqueous base fluid, viscosifying agent, etc.) may be combined and mixed in by using any mixing device compatible with the composition, e.g., a mixer, a blender, etc.

An AHM (e.g., EHM and/or CAHM) of the type disclosed herein may be included in any suitable wellbore servicing fluid (WSF). In various embodiments, an AHM may be included in a WSF (e.g., an aqueous based WSF) and function as a fluid loss additive therein. As used herein, a “servicing fluid” or “treatment fluid” refers generally to any fluid that may be used in a subterranean application in conjunction with a desired function and/or for a desired purpose, including but not limited to fluids used to drill, complete, work over, fracture, repair, or in any way prepare a wellbore for the recovery of materials residing in a subterranean formation penetrated by the wellbore. The servicing fluid is for use in a wellbore that penetrates a subterranean formation. It is to be understood that “subterranean formation” encompasses both areas below exposed earth and areas below earth covered by water such as ocean or fresh water.

Examples of wellbore servicing fluids include, but are not limited to, drilling fluids or muds, spacer fluids, lost circulation fluids, cement slurries, washing fluids, sweeping fluids, acidizing fluids, fracturing fluids, gravel packing fluids, diverting fluids or completion fluids. Nonlimiting examples of drilling fluids suitable for use in the present disclosure include spud muds, lignosulfonate muds, freshwater lignosulfonate muds, freshwater lignite muds, freshwater gel muds, seawater muds, saltwater muds, saturated saltwater muds, KCl/polymer muds, xantham gum or XC-polymer muds, KCl/XC-polymer muds, lime muds, gyp muds, silicate muds, potassium muds, polymer muds, low-solids muds, low-solids non-dispersed muds (LSND), low-solids polymer muds, mixed metal oxide muds, polyglycol muds, potassium formate muds, CaCl₂/polymer muds, PHPA muds, highly inhibitive PHPA muds, and the like, or combinations thereof.

In an embodiment, the components of the WSF are combined at the well site; alternatively, the components of the WSF are combined off-site and are transported to and used at the well site. In an embodiment, additional FLAs (e.g., conventional FLAs) may be added to the WSF on-the-fly (e.g., in real time or on-location) along with the other components/additives. The resulting WSF may be pumped downhole where the AHM of the WSF may function as intended (e.g., modify the permeability of at least a portion of a wellbore and/or subterranean formation or otherwise reduce an amount of fluid loss from the WSF to the wellbore and/or surrounding formation.).

In an embodiment, the WSF may be utilized in a drilling and completion operation. In such an embodiment, a WSF as disclosed herein is utilized as a drilling mud by being circulated through the wellbore while the wellbore is drilled in a conventional manner. As will be appreciated by one of skill in the art viewing this disclosure, as the WSF is circulated through the wellbore, a portion of the WSF is deposited on the walls (e.g., the interior bore surface) of the wellbore, thereby forming a filter cake and modifying the permeability of at least a portion of a wellbore and/or subterranean formation. The solids contained in the WSF (e.g., drilling fluid) may contribute to the formation of the filter cake about the periphery of the wellbore during the drilling of the well. In such embodiments, the filter cake comprises an AHM (e.g., EHM and/or CAHM) of the type disclosed herein that may function as a FLA to reduce an amount of fluid loss from the WSF and/or the filter cake to the adjacent wellbore wall and/or surrounding formation. In an embodiment, such reduction in fluid loss may be in comparison to an otherwise similar WSF lacking an AHM of the type described herein.

In an embodiment, when desired (for example, upon the cessation of drilling operations and/or upon reaching a desired depth), the wellbore or a portion thereof may be prepared for completion. In completing the wellbore, it may be desirable to remove all or a substantial portion of the filter cake from the walls of the wellbore and/or subterranean formation. Debris such as drilling mud and filter cakes left in the wellbore can have an adverse effect on several aspects of a well's completion and production stages, from inhibiting the performance of downhole tools to inducing formation damage and plugging production tubing. As will be understood by one of ordinary skill in the art, the method for removal of the filter cake formed from the WSF comprising an AHM (e.g., EHM and/or CAHM) of the type disclosed herein will depend on the chemical composition of the WSF and AHM. In some embodiments, the filter cake comprises a material that degrades over some time period upon exposure to typical wellbore conditions (e.g. temperature, pH, etc.). In some other embodiments, removing the filter cake may comprise contacting a breaking agent (e.g., acidic compounds, acid precursors, breakers, oxidizers, etc.) with the filter cake to remove all or a portion thereof.

In an embodiment, the WSF comprising an AHM (e.g., EHM and/or CAHM) of the type disclosed herein may be advantageously employed as a servicing fluid in the performance of one or more wellbore servicing operations. For example, when utilizing a WSF, the temperature range where the WSF is useful is limited by the temperature stability of the components of the WSF. In an embodiment, a WSF (e.g., an aqueous based drilling fluid) comprising an AHM (e.g., EHM and/or CAHM) of the type disclosed herein may be advantageously employed under challenging wellbore conditions, such as for example bottom hole temperatures (BHTs) ranging from about 250° F. to about 500° F., alternatively from about 250° F. to about 450° F., or alternatively from about 250° F. to about 400° F.

In an embodiment, the WSF comprising an AHM (e.g., EHM and/or CAHM) of the type disclosed herein presents the advantage of employing naturally-occurring materials (e.g., humus-based materials) that are widely-available and cost effective, thereby rendering the WSFs cost effective. Generally, conventional FLAs for high temperature applications (e.g., BHTs of equal to or greater than about 300° F.) are expensive and can drive up the cost of the wellbore servicing operation.

In an embodiment, the AHMs of the WSF may have more than one function while being part of the WSF. For example, an AHM that is part of a drilling fluid may function as a FLA and also as a mud lubricant, torque and drag reducer, deflocculant, etc. Additional advantages of the WSF comprising an AHM and/or the methods of using the same may be apparent to one of skill in the art viewing this disclosure.

### EXAMPLES

The embodiments having been generally described, the following examples are given as particular embodiments of the disclosure and to demonstrate the practice and advantages thereof. It is understood that the examples are given by way of illustration and are not intended to limit the specification or the claims in any manner.

### Example 1

The properties of a wellbore servicing fluid comprising an AHM were investigated. Specifically, the ability of an EHM to act as a fluid loss additive was investigated. An EHM (e.g., ethoxylated CARBONOX filtration control agent) material was prepared by reacting ethylene oxide with CARBONOX filtration control agent in a weight ratio of ethylene oxide to CARBONOX filtration control agent of 25:1. The ethylene oxide was reacted with the CARBONOX filtration control agent in an oxygen free atmosphere; in the presence of sodium methoxide as a strong base catalyst; using xylene as an inert reaction solvent; at a temperature of about 150° C.; at a pressure of from about 50 psi to about 100 psi; and for a time period of 2 h. The ethoxylated CARBONOX filtration control agent was recovered by filtration of the reaction mixture followed by distillation of xylene until a brown, amorphous, waxy solid (i.e., the EHM) was obtained. The melting point of the ethoxylated CARBONOX filtration control agent was determined to be 30-33° C. by using a melting point tube apparatus. The ethoxylated CARBONOX filtration control agent was over 95 wt. % water soluble, and the solubility of the ethoxylated CARBONOX filtration control agent was found to be independent of pH.

A 5 wt. % solution of ethoxylated CARBONOX filtration control agent in water was prepared, and this solution was tested by filtering through paper filtration media in standard laboratory glassware. The testing of this solution was attempted in two separate experiments. In one experiment, the filtration was conducted at reduced pressure. In the other experiment, the filtration was conducted at an overpressure of 100 psi. The ethoxylated CARBONOX filtration control agent plugged the filter in both experiments and prevented the water from passing through the filter.

### ADDITIONAL DISCLOSURE

A first embodiment which is a method of servicing a wellbore in a subterranean formation comprising:
preparing a wellbore servicing fluid comprising an alkoxylated humus material and an aqueous base fluid, wherein the alkoxylated humus material comprises an ethoxylated humus material and/or a C3+ alkoxylated humus material; and
placing the wellbore servicing fluid in the wellbore and/or subterranean formation to modify the permeability of at least a portion of the wellbore and/or subterranean formation.

A second embodiment, which is a method of drilling a wellbore in a subterranean formation comprising:
preparing a drilling fluid comprising an alkoxylated humus material and an aqueous base fluid, wherein the alkoxylated humus material comprises an ethoxylated humus material and/or a C3+ alkoxylated humus material; and
placing the drilling fluid in the wellbore and/or subterranean formation.

A third embodiment, which is the method of any of the first through the second embodiments wherein the alkoxylated humus material is obtained by heating a humus material with an alkoxylating agent, in the presence of a catalyst and an inert reaction solvent, wherein the alkoxylating agent comprises ethylene oxide, a C3+ cyclic ether, or combinations thereof.

A fourth embodiment, which is the method of the third embodiment wherein the humus material comprises brown coal, lignite, subbituminous coal, leonardite, humic acid, a compound characterized by Structure I, fulvic acid, humin, peat, lignin, or combinations thereof.

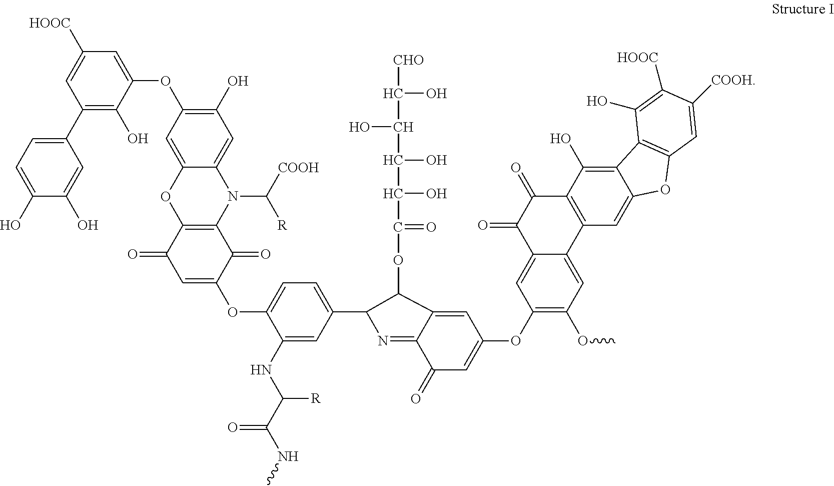

A fifth embodiment, which is the method of any of the third through the fourth embodiments wherein the C3+ cyclic ether comprises oxetane as characterized by Structure II, a C3+ epoxide compound characterized by Structure III, or combinations thereof,

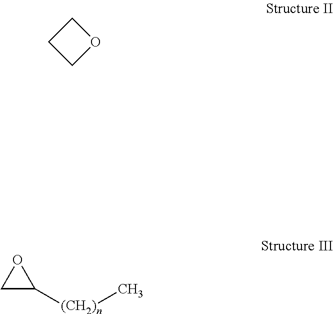

wherein the repeating methylene (—CH₂—) unit may occur n times with the value of n ranging from about 0 to about 3.

A sixth embodiment, which is the method of the fifth embodiment wherein the C3+ epoxide compound characterized by Structure III comprises propylene oxide as characterized by Structure IV, butylene oxide as characterized by Structure V, pentylene oxide as characterized by Structure VI, or combinations thereof.

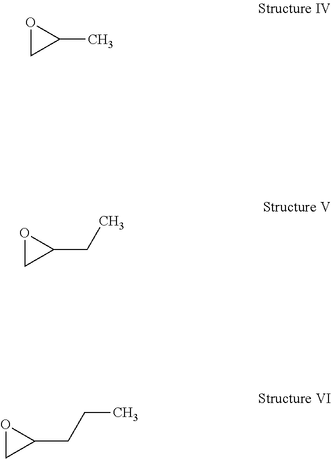

A seventh embodiment, which is the method of any of the third through the sixth embodiments wherein the alkoxylating agent is present in a weight ratio of alkoxylating agent to humus material of from about 10:1 to about 40:1.

An eighth embodiment, which is the method of any of the third through the seventh embodiments wherein the alkoxylating agent comprises ethylene oxide and C3+ cyclic ether in a weight ratio of ethylene oxide to C3+ cyclic ether in the range of from about 10:1 to about 1:10.

A ninth embodiment, which is the method of any of the third through the eighth embodiments wherein the catalyst comprises a strong base catalyst and the C3+ alkoxylated humus material comprises a compound characterized by Structure VII:

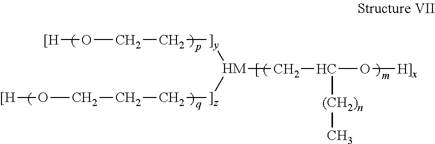

wherein HM represents the humus material; n is in the range of from about 0 to about 3; m is in the range of from about 1 to about 30; x is in the range of from about 0 to about 300, per 100 g of humus material; p is in the range of from about 1 to about 30; y is in the range of from about 0 to about 200, per 100 g of humus material; q is in the range of from about 1 to about 30; z is in the range of from about 0 to about 300, per 100 g of humus material; and x, y and z cannot all be 0 at the same time.

A tenth embodiment, which is the method of any of the third through the eighth embodiments wherein the catalyst comprises a strong acid catalyst and the C3+ alkoxylated humus material comprises a compound characterized by Structure VIII:

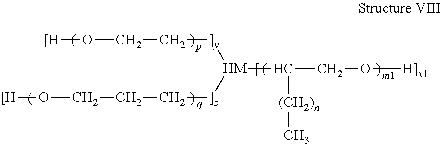

wherein HM represents the humus material; n is in the range of from about 0 to about 3; m1 is in the range of from about 1 to about 30; x1 is in the range of from about 0 to about 300, per 100 g of humus material; p is in the range of from about 1 to about 30; y is in the range of from about 0 to about 200, per 100 g of humus material; q is in the range of from about 1 to about 30; z is in the range of from about 0 to about 300, per 100 g of humus material; and x1, y and z cannot all be 0 at the same time.

An eleventh embodiment, which is the method of any of the first through the fourth embodiments wherein the ethoxylated humus material comprises a compound characterized by Structure XL:

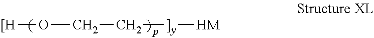

wherein HM represents the humus material; p is in the range of from about 1 to about 30; and y is in the range of from about 1 to about 200, per 100 g of humus material.

A twelfth embodiment, which is the method of any of the first through the eleventh embodiments wherein the alkoxylated humus material has a temperature stability of from about 25° F. to about 500° F.

A thirteenth embodiment, which is the method of any of the first through the twelfth embodiments wherein the alkoxylated humus material is present in the wellbore servicing fluid in an amount of from about 0.25 wt. % to about 5.0 wt. % based on the total weight of the wellbore servicing fluid.

A fourteenth embodiment, which is the method of any of the first through the thirteenth embodiments wherein the aqueous base fluid comprises a brine.

A fifteenth embodiment, which is the method of the fourteenth embodiment wherein the brine is present in the wellbore servicing fluid in an amount of from about 1 wt. % to about 99 wt. % based on the total weight of the wellbore servicing fluid.

A sixteenth embodiment, which is the method of any of the first through the fifteenth embodiments wherein the wellbore servicing fluid further comprises a viscosifying agent.

A seventeenth embodiment, which is the method of any of the first through the sixteenth embodiments wherein the wellbore servicing fluid is a drilling fluid.

An eighteenth embodiment, which is a method of servicing a wellbore in a subterranean formation comprising:
preparing a wellbore servicing fluid comprising an alkoxylated humus material and an aqueous base fluid, wherein the alkoxylated humus material comprises an ethoxylated lignite; and
placing the wellbore servicing fluid in the wellbore and/or subterranean formation to modify the permeability of at least a portion of the wellbore and/or subterranean formation.

A nineteenth embodiment, which is the method of the eighteenth embodiment wherein the ethoxylated lignite was prepared by reacting ethylene oxide with lignite in a weight ratio of ethylene oxide to lignite of from about 10:1 to about 40:1.

A twentieth embodiment, which is the method of any of the eighteenth through the nineteenth embodiments wherein the wellbore servicing fluid is a drilling fluid.

A twenty-first embodiment, which is a pumpable wellbore servicing fluid comprising an alkoxylated humus material in an amount of from about 0.25 wt. % to about 5.0 wt. % based on the total weight of the wellbore servicing fluid, wherein the alkoxylated humus material comprises an ethoxylated humus material and/or a C3+ alkoxylated humus material.

A twenty-second embodiment, which is the wellbore servicing fluid of the twenty-first embodiment formulated as an aqueous based drilling fluid.

While embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R_{L}, and an upper limit, R_{U}, is disclosed, any number falling within the range is specifically disclosed. In particular, the following numbers within the range are specifically disclosed: R=R_{L}+k*(R_{U}−R_{L}), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the embodiments of the present invention. The discussion of a reference in the Description of Related Art is not an admission that it is prior art to the present invention, especially any reference that may have a publication date after the priority date of this application. The disclosures of all patents, patent applications, and publications cited herein are hereby incorporated by reference, to the extent that they provide exemplary, procedural or other details supplementary to those set forth herein.

1. A method of servicing a wellbore in a subterranean formation comprising:
preparing a wellbore servicing fluid comprising an alkoxylated humus material and an aqueous base fluid, wherein the alkoxylated humus material comprises an ethoxylated humus material and/or a C3+ alkoxylated humus material; and
placing the wellbore servicing fluid in the wellbore and/or subterranean formation to modify the permeability of at least a portion of the wellbore and/or subterranean formation.

2. (canceled)

3. The method of claim 1 wherein the alkoxylated humus material is obtained by heating a humus material with an alkoxylating agent, in the presence of a catalyst and an inert reaction solvent, wherein the alkoxylating agent comprises ethylene oxide, a C3+ cyclic ether, or combinations thereof.

4. The method of claim 3 wherein the humus material comprises brown coal, lignite, subbituminous coal, leonardite, humic acid, a compound characterized by Structure I, fulvic acid, humin, peat, lignin, or combinations thereof.

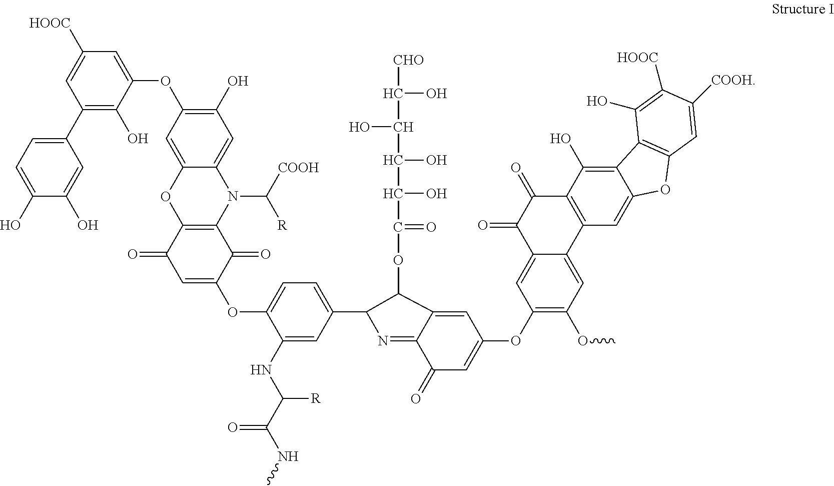

5. The method of claim 3 wherein the C3+ cyclic ether comprises oxetane as characterized by Structure II, a C3+ epoxide compound characterized by Structure III, or combinations thereof, 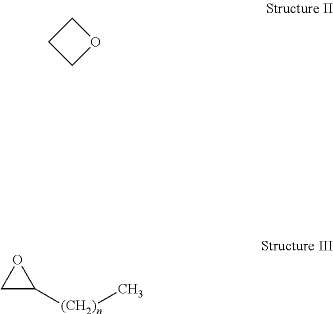
wherein the repeating methylene (—CH₂—) unit may occur n times with the value of n ranging from about 0 to about 3.

6. The method of claim 5 wherein the C3+ epoxide compound characterized by Structure III comprises propylene oxide as characterized by Structure IV, butylene oxide as characterized by Structure V, pentylene oxide as characterized by Structure VI, or combinations thereof.

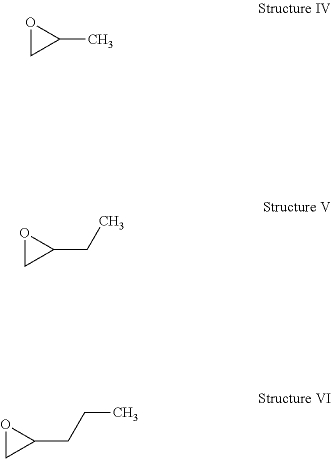

7. The method of claim 3 wherein the alkoxylating agent is present in a weight ratio of alkoxylating agent to humus material of from about 10:1 to about 40:1.

8. The method of claim 3 wherein the alkoxylating agent comprises ethylene oxide and C3+ cyclic ether in a weight ratio of ethylene oxide to C3+ cyclic ether in the range of from about 10:1 to about 1:10.

9. The method of claim 3 wherein the catalyst comprises a strong base catalyst and the C3+ alkoxylated humus material comprises a compound characterized by Structure VII: 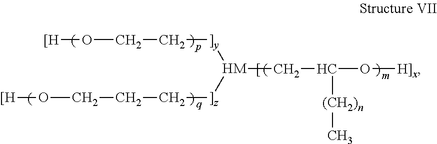
wherein HM represents the humus material; n is in the range of from about 0 to about 3; m is in the range of from about 1 to about 30; x is in the range of from about 0 to about 300, per 100 g of humus material; p is in the range of from about 1 to about 30; y is in the range of from about 0 to about 200, per 100 g of humus material; is in the range of from about 1 to about 30; z is in the range of from about 0 to about 300, per 100 g of humus material; and x, y, and z cannot all be 0 at the same time.

10. The method of claim 3 wherein the catalyst comprises a strong acid catalyst and the C3+ alkoxylated humus material comprises a compound characterized by Structure VIII: 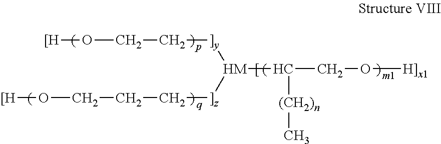
wherein HM represents the humus material; n is in the range of from about 0 to about 3; m1 is in the range of from about 1 to about 30; x1 is in the range of from about 0 to about 300, per 100 g of humus material; p is in the range of from about 1 to about 30; y is in the range of from about 0 to about 200, per 100 g of humus material; q is in the range of from about 1 to about 30; z is in the range of from about 0 to about 300, per 100 g of humus material; and x1, y and z cannot all be 0 at the same time.

11. The method of claim 1 wherein the ethoxylated humus material comprises a compound characterized by Structure XL: 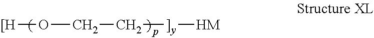
wherein HM represents the humus material; p is in the range of from about 1 to about 30; and y is in the range of from about 1 to about 200, per 100 g of humus material.

12. The method of claim 1 wherein the alkoxylated humus material has a temperature stability of from about 25° F. to about 500° F.

13. The method of claim 1 wherein the alkoxylated humus material is present in the wellbore servicing fluid in an amount of from about 0.25 wt. % to about 5.0 wt. % based on the total weight of the wellbore servicing fluid.

14. The method of claim 1 wherein the aqueous base fluid comprises a brine.

15. (canceled)

16. The method of claim 1 wherein the wellbore servicing fluid further comprises a viscosifying agent.

17. The method of claim 1 wherein the wellbore servicing fluid is a drilling fluid.

18. A method of servicing a wellbore in a subterranean formation comprising:
preparing a wellbore servicing fluid comprising an alkoxylated humus material and an aqueous base fluid, wherein the alkoxylated humus material comprises an ethoxylated lignite; and
placing the wellbore servicing fluid in the wellbore and/or subterranean formation to modify the permeability of at least a portion of the wellbore and/or subterranean formation.

19. The method of claim 18 wherein the ethoxylated lignite was prepared by reacting ethylene oxide with lignite in a weight ratio of ethylene oxide to lignite of from about 10:1 to about 40:1.

20. The method of claim 18 wherein the wellbore servicing fluid is a drilling fluid.

21. A pumpable wellbore servicing fluid comprising an alkoxylated humus material in an amount of from about 0.25 wt. % to about 5.0 wt. % based on the total weight of the wellbore servicing fluid, wherein the alkoxylated humus material comprises an ethoxylated humus material and/or a C3+ alkoxylated humus material.

22. The wellbore servicing fluid of claim 21 formulated as an aqueous based drilling fluid.
